(19) United States
(12) Patent Application Publication
(10) Pub. No.: US 2024/0426710 A1
(43) Pub. Date: Dec. 26, 2024

(54) ELLIPSOID-BASED METHOD FOR QUANTITATIVE DESCRIPTION OF FAULT AND FISSURE AND DETECTION SYSTEM THEREOF

(71) Applicant: North China University of Water Resources and Electric Power, Zhengzhou City (CN)

(72) Inventors: Xubiao DENG, Zhengzhou City (CN); Chengjie YANG, Zhengzhou City (CN); Huaichang YU, Zhengzhou City (CN); Qi WU, Zhengzhou City (CN); Shizhong CHEN, Zhengzhou City (CN); Xinyue WANG, Zhengzhou City (CN); Chenhui JING, Zhengzhou City (CN); Yanjie HOU, Zhengzhou City (CN); Jiaxin MA, Zhengzhou City (CN); Zhenfa YANG, Zhengzhou City (CN)

(21) Appl. No.: 18/522,550

(22) Filed: Nov. 29, 2023

(30) Foreign Application Priority Data
Jun. 26, 2023 (CN) 202310759329.5
Jun. 26, 2023 (CN) 202310759330.8

(51) Int. Cl. G01M 99/00; G01B 21/04

(52) U.S. Cl. CPC G01M 99/00; G01B 21/04

(57) ABSTRACT

A method for quantitative description of a fault/fissure and a detection system thereof are provided, involving static and dynamic method and system for quantitative description. The present static method for quantitative description includes: according to spatial coordinate data of the fault/fissure, constructing a fissure ellipsoid that covers a spatial distribution scope of the fault/fissure; and characterizing the fault/fissure according to spatial geometric parameters of the fissure ellipsoid. And the present dynamic method for quantitative description includes: according to waveform parameters of elastic waves generated during rupture process, constructing a three-dimensional hypocenter ellipsoid that covers spatial radiation; and according to spatial geometric parameters of the ellipsoid, determining a hypocenter location, an energy level, and/or orientation of the fissure. The present application is more intuitive and simpler in quantitatively describing static geometric characteristics of the fissure and dynamic physical characteristics of the hypocenter.

### BACKGROUND OF THE APPLICATION

### 1. Technical Field

The present disclosure generally relates to analysis of information about geographical fissure structures, and also relates to elastic-wave detection. More particularly, the present disclosure relates to an ellipsoid-based method for quantitative description of fault and fissure and a detection system thereof.

### 2. Description of Related Art

A geologic body or a solid material piece usually contains structural defects of various scales. These structural defects can have significant influence on the physical and mechanical properties of solid materials. Quantitative description of such structural defects is currently a common challenge in the fields of rock mechanics, structural mechanics, and mechanics of solid materials. As another fact, a solid object when receiving external force tends to have new internal fissures generated and/or have existing fissures expanded or interconnected into larger fissures. Coming together with generation, expansion, and interconnection of fissures are elastic waves, which are shown as natural earthquakes, microseisms, and/or acoustic emission in different scales carrying damage evolution characteristics in the solid object. Acoustic emission is often used for dynamic monitoring and assessment of bridges and metal pressure vessels in terms of structural fatigue damage. Microseisms are extensively used in scenarios where monitoring and warning of geological disaster related to failure of rocks are required. Natural seismic waves on the other hand provide valuable information about earthquakes and internal structures of the earth. A major objective of detection of natural earthquakes, microseisms, acoustic emission as hypocenter elastic-wave is to quantitatively describe fissures and their dynamic processes, thereby enabling determination of system evolution. Currently, detection of fissures in solid objects in terms of size and orientation is implemented using either X-ray computed tomography or elastic-wave computed tomography. XCT involves CT-guided scanning detection followed by three-dimensional reconstruction, so as to obtain information about three-dimensional structures of fissure at micron level accuracy. However, the existing method is limited to CT scanning speed and unfit to dynamic detection. A new CT technique uses a particle accelerator to get high-speed particles, so as to speed up the slicing process, thereby having its ability to detect variation of dynamic structures significantly improved. Nevertheless, facilities for XCT are disadvantageously bulky, and dynamic CT is limited in terms of application for it requires high-speed particles, so these approaches can often be unsuitable for in-situ implementations. Elastic-wave CT is about scanning solid structures using seismic waves or ultrasound, and getting information of fissure structures in solid objects through analyzing velocity variation of waves. Its accuracy and range of detection are dependent on the wavelength used. Specifically, the smaller the wavelength is, the more accurate the detection result is, while the smaller the detection range is. Besides, the existing elastic-wave CT is not useful for quantitative description of three-dimensional fissure structures. Expect for high-speed CT, none of the foregoing known methods is capable of quantitative description of fissure structures and their fissuring processes.

Kachanov et al. in their paper titled “Continuum model of medium with cracks” (Journal of the Engineering Mechanics Division, 1980, 106(5):1039-1051.) use fissure tensors to enable statistical description of fissures inside solid objects. LI Xuefeng et al. in their paper titled “Quantitative determination of crack fabric for rock” (Journal of Rock Mechanics and Geotechnical Engineering, 2015, 34(11): 2355-2361) define tensor of fissures with normalization. While the tensor can better characterize planar distribution of fissures, it is irrelevant to quantitative description of three-dimensional structures, and therefore is not suitable for description of fissures in terms of three-dimensional dynamics.

WANG Shouguang et al. in their paper titled “Ellipsoid reconstruction and tensor characterization of planar fractures in coal obtained by CT-scanning and the applications” (Journal of China Coal Society, 2022, 47(7):2593-2608.) employ a rotational oblate ellipsoid and perform fitting for each triangular surface fissure, thereby accomplishing ellipsoid-based reconstruction of the entire fissure structure. However, the known ellipsoid-based method for fissure filling is complicated for involving multiple ellipsoids, making it less practical in quantitation of mechanics. Besides, it is not suitable for post-fissure characterization.

Petra Adamová et al. (Non-Double-Couple Earthquake Mechanism as an Artifact of the Point-Source Approach Applied to a Finite-Extent Focus [J] Bulletin of the Seismological Society of America (2010) 100 (2): 447-457.) use the second moment approximation of the moment tensor to perform inversion fitting for a hypocenter ellipsoid, wherein the hypocenter ellipsoid varies with frequency components of seismic waves. The known method involves complicated computing yet the resulting hypocenter ellipsoid is useless in describing the physical process of the hypocenter.

As another example, China Patent Publication No. CN111965696A discloses a dynamic disaster prediction method based on elastic wave multi-target analysis, which comprises the following steps. At S1, during operation, an acoustic emission monitoring device is used for collecting and sending elastic wave signals transmitted in a measured target body. At S2, the ground comprehensive signal processing device receives and analyzes the elastic wave signals to obtain abnormal geologic bodies in the measured target body and dynamic inversion imaging of stress changes, and acoustic emission characteristic parameters of the elastic wave signals are extracted at the same time. At S3, the ground comprehensive signal processing device carries out disaster judgment and intelligent early warning according to the change condition of the abnormal geologic body dynamic inversion imaging or the change condition of the stress change dynamic inversion imaging or the change condition of the acoustic emission characteristic parameter in the measured target body. Although the existing method based on characteristic parameters of elastic-wave acoustic emission is somehow effective in disaster prediction, it only provides overview of geological occurrence in the detected object primary through inversion imaging for abnormal geologic bodies in the detected object but not accurate characterization of fault/fissures.

Some of the aforementioned known ellipsoid-based methods for characterization of fissures are disadvantageously complicated for involving multiple ellipsoids for filling and description and inconvenient for applications, and the others are incapable of describing three-dimensional characteristics of fault/fissures.

Moreover, when a solid object such as a rock receives external force, its existing fissures can expand and interconnect while new fissures can occur. Accompanying with formation of fissures, elastic waves can occur. Depending on its scale, an elastic wave may be in the form of a natural earthquake, a microseism, or acoustic emission. Generally, detection of such elastic waves is achieved using detectors and the obtained data can be used to characterize fissures around the hypocenter. By characterizing fault/fissures at the hypocenter based on waveform features, information of the hypocenter can be obtained for further analysis.

Dynamic detection of fissures around a hypocenter is generally achieved using vibration detectors. A vibration detector detects fissure structures in a solid object by scanning with a seismic or ultrasound wave and analyzing velocity variation of the wave. However, with only features of the elastic wave such collected, it is difficult, if not impossible, to learn dynamic physical characteristics of the hypocenter. Therefore, there is an unmet need for effectively processing elastic wave data collected by a vibration detector and accordingly forming an exclusive ellipsoid that dynamically characterize physical features of a hypocenter through fitting. To meet such a need, China Patent Publication No. CN111965696A, for example, discloses a dynamic disaster prediction method based on elastic wave multi-target analysis, which comprises the following steps. At S1, during operation, an acoustic emission monitoring device is used for collecting and sending elastic wave signals transmitted in a measured target body. At S2, the ground comprehensive signal processing device receives and analyzes the elastic wave signals to obtain abnormal geologic bodies in the measured target body and dynamic inversion imaging of stress changes, and acoustic emission characteristic parameters of the elastic wave signals are extracted at the same time. At S3, the ground comprehensive signal processing device carries out disaster judgment and intelligent early warning according to the change condition of the abnormal geologic body dynamic inversion imaging or the change condition of the stress change dynamic inversion imaging or the change condition of the acoustic emission characteristic parameter in the measured target body. The known method boasts the ability to greatly improve prediction accuracy, greatly improve prediction work efficiency and reduce prediction cost by comprehensively and accurately predicting and providing early warn dynamic disasters. However, as it performs inversion only according to elastic-wave signals but not an ellipsoid model that describes dynamic variation, the only way for it to achieve dynamic inversion imaging is to continuously update inversion imaging of abnormal geologic bodies and stress variation. As a result, the known method needs to process a huge amount of data, and tends to lead to serious deviation in dynamic inversion imaging when any circle of inversion is problematic.

Hence, approaches to using a single ellipsoid to characterize fault/fissures so as to provide quantitative description of three-dimensional structures, and to characterizing hypocenter and fissures around it precisely through characterization of dynamic variation of the fissures are issues to be addressed in the art.

Since there is certainly discrepancy between the existing art comprehended by the applicant of this patent application and that known by the patent examiners and since there are many details and disclosures disclosed in literatures and patent documents that have been referred by the applicant during creation of the present disclosure not exhaustively recited here, it is to be noted that the present disclosure shall actually include technical features of all of these existing works, and the applicant reserves the right to supplement the application with the related art more existing technical features as support according to relevant regulations.

### SUMMARY OF THE APPLICATION

There has not been an effective approach to performing quantitative description of structure defects in a solid object during a mechanical process. This is because that the elastic-wave CT method uses seismic waves or ultrasound to scan a solid structure and get information about fissure structures inside the solid by reading changes in wave velocity. The accuracy and detection range of a CT detection device are determined by the wavelength on which it works. To be specific, the smaller the wavelength is, the higher the accuracy is, whereas the smaller the detection range is. Characterization of a fissure is performed according to the fissure structure determined using elastic-wave CT is necessarily limited to the low-accuracy data so collected and leads to inaccuracy. There is apparently a need for further processing data about structural features of fissures collected by existing CT-based detecting apparatuses in order to improve the data in terms of accuracy. Hence, how to process data collected by the existing CT-based detecting apparatuses into a single fissure ellipsoid through fitting and accurately and quantitatively describe geometric characteristics of fissures according to the fissure ellipsoid is a technical issue to be addressed by the present disclosure.

The inventors of the present disclosure creatively propose a static method for geometric characterization of fault/fissures and a dynamic method for physical characterization of a hypocenter.

In order to address the shortcomings of the existing art, the present disclosure provides a static method for quantitative description of fault/fissures. In the method, a fissure ellipsoid obtained through fitting accurately reflects occurrence of fissures. The method at least comprises: collecting spatial coordinate data of the fault/fissures; according to the spatial coordinate data, constructing a fundamental elliptic equation that covers a spatial distribution scope of the fault/fissures; and characterizing the fault/fissures according to spatial geometric parameters of the fissure ellipsoid which is formed through fitting by using the fundamental elliptic equation. In the present disclosure, ellipsoid fitting is performed on the collected spatial coordinate data, and then physical characteristics of the fissures can be obtained from the spatial geometric parameters of the resulting ellipsoid. In other words, even with moderate-accuracy data about spatial coordinates of fissures, the present disclosure featuring ellipsoid fitting can provide accurate quantitative description according to spatial geometric parameters of the three-dimensional ellipsoid, so as to ensure good quantitative description in spite of moderate-accuracy spatial coordinate data.

Preferably, the step of, according to the spatial coordinate data, constructing a fundamental elliptic equation that covers a spatial distribution scope of the fault/fissures comprises: according to the spatial coordinate data, constructing a polyhedron that covers the spatial distribution scope of the fault/fissures; based on a geometric structure of the polyhedron, determining a center of gravity of the polyhedron; according to the center of gravity and fissure vectors that are each formed by linking the center of gravity and a point of the spatial coordinate data, constructing the fundamental elliptic equation that covers the spatial distribution scope; and based on the fundamental elliptic equation, forming the three-dimensional fissure ellipsoid. In the present disclosure, the fissure ellipsoid is such constructed that it completely covers the spatial distribution scope of the fault/fissures and minimizes coverage error.

Preferably, the step of, according to the spatial coordinate data, constructing a fundamental elliptic equation that covers a spatial distribution scope of the fault/fissures further comprises: according to quantity of the spatial coordinate data, determining a way by which a coefficient of the fundamental elliptic equation is fit; and according to the coefficient of the fundamental elliptic equation, determining the spatial geometric parameters of the fissure ellipsoid. For example, with sufficient information of spatial coordinates, the coefficient of the fundamental elliptic equation can be figured out without interpolation. Preferably, at least 4 sets of spatial coordinates are used for it to be possible to construct a geometrical cube and to define the spatial distribution scope of the spatial coordinate data. Thereby, the spatial coordinate data can be transformed into the three-dimensional ellipsoid that covers the spatial distribution scope.

Preferably, the step of, according to quantity of the spatial coordinate data, determining away by which a coefficient of the fundamental elliptic equation is fit at least comprises: where the quantity of the received spatial coordinate data is not smaller than a predetermined data threshold, directly determining the coefficient of the fundamental elliptic equation through fitting; and where the quantity of the received spatial coordinate data is smaller than the predetermined data threshold, fitting the coefficient of the fundamental elliptic equation by means of performing random interpolation in a principal plane of the fissure ellipsoid. The prior art does not provide any method to cover the fault or fissure with an ellipsoid, and the present disclosure first provides the method to perform ellipsoid fitting through the points on the three-dimensional boundary of the fault or fissure, and if data deficiency is confirmed, interpolation is implemented for complement before fitting is performed. The way to conduct fitting as disclosed in the present disclosure can result in calculation and quantitative description more accurate than the existing methods.

Preferably, the method further includes: based on a third axis parameter of the fissure ellipsoid, describing geometric characteristics of a solid structural defect related to a width; and based on an area and/or a normal direction of the principal plane of the fissure ellipsoid, describing spatial characteristics of the solid structural defect. To address the shortcomings of the existing art, the system of present disclosure constructs a fundamental elliptic equation based on fissure spatial coordinate data from elastic waves. The present disclosure can accurately characterize fault/fissures according to spatial geometric parameters of a single ellipsoid, to, for example, describe spatial extension of the faults, the width of the fault band, apertures of the fissures, spatial sizes of the fissures, etc. The present disclosure can even use the average coverage ratio between an ellipsoid and the spatial distribution scope of the fissure vectors to assessment ellipsoid fitting quality, thereby enabling wise choice among ellipsoids to accurately characterize the fault/fissures. Since the ellipsoid has its spatial geometric parameters associated with the physical characteristics of fissures, the present disclosure can describe geometric characteristics and spatial characteristics of fissures using the spatial geometric parameters of the ellipsoid. The calculation is simple and the standard is consistent.

Preferably, the method further comprises: based on an average coverage ratio of the fissure ellipsoid with respect to the fissure vectors, assessing ellipsoid fitting quality. According to the present disclosure, the average coverage ratio is indicative of the quality of ellipsoid fitting, thereby facilitating exclusion ellipsoids with inferior fitting quality.

The present disclosure further provides a system for quantitative detection of a fault/fissure, wherein the system at least comprises coordinate collecting components and at least one processor, the coordinate collecting components at least collect spatial coordinate data of the fault/fissure and send the data to the processor. The processor is for, according to the spatial coordinate data, constructing a fundamental elliptic equation that covers a spatial distribution scope of the fault/fissure; and according to spatial geometric parameters of a three-dimensional fissure ellipsoid constructed from the fundamental elliptic equation, characterizing the fault/fissure. The detection system of the present disclosure constructs a fissure ellipsoid simply and accurately without real-time data processing, so the service life of the detection system can be extended.

Preferably, the processor is further for: based on a third axis parameter of the fissure ellipsoid, describing geometric characteristics of a solid structural defect related to a width; and based on an area and/or a normal direction of a principal plane of the fissure ellipsoid, describing spatial characteristics of the solid structural defect. Based on operation of the predetermined description program, the processor of the present disclosure can accurately describe geometric characteristics and spatial characteristics of fissures according to spatial geometric parameters of the fissure ellipsoid.

Preferably, the processor is further for: based on an average coverage ratio of the fissure ellipsoid with respect to the fissure vectors, assessing ellipsoid fitting quality. The processor can exclude fissure ellipsoids with inferior fitting quality according to their average coverage ratios obtained through calculation, and preserve the fissure ellipsoid with good fitting quality.

The present disclosure further provides an ellipsoid-based method for quantitative description of a fault/fissure hypocenter, which is a dynamic method. The method at least comprises: collecting amplitude data of elastic waves generated during rupture process; constructing a three-dimensional fundamental elliptic equation that covers spatial radiation of the hypocenter; according to the fundamental elliptic equation, constructing a three-dimensional hypocenter ellipsoid; and according to spatial geometric parameters of the ellipsoid, determining a hypocenter location, its energy level, and/or orientation of the fissure. The method uses a sole and single hypocenter ellipsoid to represent or describe physical characteristics of the hypocenter, thereby obtaining physical parameters of the hypocenter. The calculation is simple and the physical process is clear and intuitive. Even people without professional background can easily understand.

Preferably, the method further includes: representing stress triaxiality, stress status and/or stress orientation based on parameters of three axes of the ellipsoid; and based on fitting relation between the energy level and the stress, establishing relation between the parameters of the three axes of the hypocenter ellipsoid and the stress, thereby determining a stress tensor and variation thereof. Using the spatial geometric parameters of the hypocenter ellipsoid to describe the energy level and stress statuses of the hypocenter is advantageous for enhanced accuracy.

Preferably, the step of constructing a three-dimensional fundamental elliptic equation that covers spatial radiation of the hypocenter at least comprises: according to quantity of the spatial coordinate data, determining a way by which a coefficient of the fundamental elliptic equation is fit; and according to the coefficient of the fundamental elliptic equation, determining the spatial geometric parameters of the hypocenter ellipsoid. By properly determining the way to perform fitting, a hypocenter ellipsoid with accurate coverage can be obtained even with insufficient collected data.

Preferably, the method further includes: connecting the location of the hypocenter and data points of the amplitude of the elastic waves to form hypocenter-detecting vectors that represent spatial propagation directions from the hypocenter; and based on an average coverage ratio of the fissure ellipsoid with respect to the hypocenter-detecting vectors, assessing ellipsoid fitting quality. By assessing the ellipsoid fitting quality, inaccurate hypocenter ellipsoids can be further excluded, thereby improving accuracy for screening hypocenter ellipsoids.

The present disclosure further provides an ellipsoid-based system for quantitative detection of a fault/fissure hypocenter, which comprises at least one elastic-wave collecting components and at least one processor, wherein the elastic-wave collecting components are for collecting waveform parameters, for example, amplitude data, cycle, frequency, phase position of elastic waves generated during rupture process and sending the data to the processor, and the processor is for: constructing a three-dimensional fundamental elliptic equation that covers spatial radiation of the hypocenter; according to the fundamental elliptic equation, constructing a three-dimensional hypocenter ellipsoid; and according to spatial geometric parameters of the ellipsoid, determining a hypocenter location, its energy level, and/or orientation of the fissure.

The detection system of the present disclosure can provide physical characteristics of the hypocenter and achieve accurate quantitative description without real-time detection. As compared to the existing methods that cannot achieve quantitative description of physical characteristics of the hypocenter without real-time detection, the present disclosure system is superior for giving accurate calculative results, and being simple, less demanding in fields, and convenient to use.

Preferably, the processor is for: representing stress triaxiality, stress status and/or stress orientation based on parameters of three axes of the ellipsoid; and based on fitting relation between the energy level and the stress, establishing relation between the parameters of the three axes of the hypocenter ellipsoid and the stress, thereby determining a stress tensor and variation thereof. The hypocenter ellipsoid obtained by the processor of the present disclosure through fitting has a unique structure, which when used in conjunction with stress can accurately determine the stress tensor and its variation, and can be used to identify the type and the energy level of the hypocenter.

### BRIEF DESCRIPTION OF THE DRAWINGS

FIG. 1 is a coordinate map showing distribution of spatial coordinate points defined by spatial coordinate data of 4 points on the spatial boundary of 1 fissure according to the present disclosure;

FIG. 2 is a coordinate map showing fissure vectors defined by spatial coordinate data of 4 points on the spatial boundary of 1 fissure according to the present disclosure;

FIG. 3 is a coordinate map showing a spatial distribution scope defined by spatial coordinate data of 4 points on the spatial boundary of 1 fissure according to the present disclosure;

FIG. 4 is a coordinate map showing distribution of spatial coordinate points defined by spatial coordinate data of 6 points on the spatial boundary of 1 fissure according to the present disclosure;

FIG. 5 is a coordinate map showing fissure vectors defined by spatial coordinate data of 6 fissures according to the present disclosure;

FIG. 6 is a coordinate map showing a spatial distribution scope defined by spatial coordinate data of 6 points on the spatial boundary of 1 fissure according to the present disclosure;

FIG. 7 is a coordinate map showing an ellipsoid that covers the fissure vectors according to the present disclosure;

FIG. 8 is a schematic drawing of the hardware structure of a system for spatial, quantitative characterization of fault/fissures according to the present disclosure;

FIG. 9 is a schematic drawing showing arrangement of elastic-wave collecting components according to a preferred implementation of the present disclosure;

FIG. 10 is a schematic drawing showing arrangement of elastic-wave collecting components according to another preferred implementation of the present disclosure;

FIG. 11 is a first exemplary hypocenter-detecting vector graph formed from six-channel amplitude data according to the present disclosure;

FIG. 12 is a second exemplary hypocenter-detecting vector graph formed from eight-channel amplitude data according to the present disclosure;

FIG. 13 shows an ellipsoid related to a shear-type hypocenter corresponding to the second hypocenter-detecting vector graph according to the present disclosure;

FIG. 14 is a third exemplary hypocenter-detecting vector graph formed from eight-channel amplitude data according to the present disclosure;

FIG. 15 shows an ellipsoid related to a shear-type hypocenter corresponding to the third hypocenter-detecting vector graph according to the present disclosure;

FIG. 16 is a fourth exemplary hypocenter-detecting vector graph formed from eight-channel amplitude data according to the present disclosure;

FIG. 17 shows an ellipsoid related to a tension-type hypocenter corresponding to the fourth hypocenter-detecting vector graph according to the present disclosure;

FIG. 18 is a fifth exemplary hypocenter-detecting vector graph formed from eight-channel amplitude data according to the present disclosure;

FIG. 19 shows an ellipsoid related to a tension-type hypocenter corresponding to the fifth hypocenter-detecting vector graph according to the present disclosure;

FIG. 20 is a coordinate map showing determination of a principal plane according to the present disclosure;

FIG. 21 is a coordinate map showing random interpolation according to the present disclosure; and

FIG. 22 illustrates deduction of hypocenter rupture velocity according to the present disclosure.

### DETAILED DESCRIPTION OF THE APPLICATION

The following description, in conjunction with the accompanying drawings and preferred embodiments, is set forth as below to illustrate the present disclosure in detail.

Some terms used in this specification are defined below.

A fissure refers to a crevice occurs in a rock due to geological functions.

A solid structure defect refers to a fissure, a structural surface, a fracture zone, a weak interlayer, an interior cavity, or the like.

A fault is a kind of geological fissures and is generated by stress in strata, earth's crust or lithosphere as rupture. Obvious displacement occurs at two sides of a rupture plane, which means a fault extends across a stratum boundary. There are many types of faults, each having a complicated form. According to another definition, “fault” is a geological term used to describe a plane or surface along which there is displacement of one side relative to the other. This displacement usually occurs as a result of movement along a break or weakness in the earth's crust. Faults can be categorized based on the direction of movement, type of movement, and amount of movement. They are an important feature of the earth's crust and can lead to earthquakes if the movement along the fault is large enough. It is a type of geological structure resulting from the breaking and displacement of rock along a plane or surface. It typically occurs when the rock is subjected to high stress or tension forces. The displacement of the rock along the fault plane can be significant, resulting in a change in the orientation or position of the rock layers. Faults are an important feature of the Earth's crust and can lead to earthquakes if the displacement is large enough. They are also used to study the geological history and evolution of the earth's crust.

A joint is a kind of fissures and is in the form of a series of regular breaks occurring in a rock under geological functions but has no obvious displacement occurs at two sides of the rupture.

Coordinate collecting components is a device for collecting spatial coordinate data of a fault/fissure so as to know characteristics of the fissure. Coordinate collecting components may be implemented as a sensor or an elastic-wave CT or XCT device. For example, various structural planes may be found using physical or geophysical means, like XCT, ultrasound CT, seismic CT. Preferably, the sensor for collecting spatial coordinate data of a fissure is preferably a wideband vibration sensor with a frequency range of 0-2 kHz (low frequency) or 2 kHz-50 MHz (high frequency), depending on the object to be monitored. For a high-frequency application, the sensor may be R6 piezoceramic sensor or a W800 piezoceramic sensor. For a low-frequency application, the sensor may be an all-fiber micro-seismic probe manufactured by Anhui Zhibo Photoelectric Technology Co., Ltd.

A processor refers to an application-specific integrated circuit and/or server, a CPU, or a single-chip microcomputer that can operate the coding program of the two spatial and quantitative description method of the present disclosure.

A center of gravity refers to the center of gravity of a solid geometry that is defined by 4 or more sets of spatial coordinate data.

A fissure vector refers to a vector pointing from the center of gravity to the spatial coordinates of the fissure.

A fissure ellipsoid is formed by first defining a sphere centered at the center of gravity, and calibrating fissure vectors in different directions and at different distances in the space against the sphere as a reference so that the fissure ellipsoid covers the solid geometry defined by the spatial coordinate data.

In the present disclosure, an exemplary spatial coordinate system has spatial coordinate axes marked in mm. The unit of the spatial coordinate axes may be defined using other units of length, while fitting of the ellipsoid is performed in the same manner.

A hypocenter refers to the site where rupture occurs in a solid object, and may be spatially expressed as coordinates (x, y, z). In the present disclosure, the hypocenter is represented by an ellipsoid, also referred to as a hypocenter ellipsoid. The hypocenter is located at the focus of the ellipsoid. Hypocenters include and are not limited to acoustic emission, microseisms, and natural earthquakes. Acoustic sources and acoustic emission sources represent processes of rupture and processes of movements of rupture planes.

A hypocenter-detecting vector refers to a vector pointing to an amplitude data point from the hypocenter, with its size expressed in amplitude.

A hypocenter sphere is formed as a sphere centered at the hypocenter (with an arbitrary radius, preferably being greater than the wavelength). Elastic-wave collecting components in different directions and at different distances in the space are used to get detection waveforms, and attenuation of the waves is calibrated against the sphere as the reference, so as to get waveforms in different directions on the sphere. Such a sphere is referred to as a hypocenter sphere in the present disclosure.

Attenuation refers to the phenomenon that the amplitude of a wave decreases due to consumption caused by propagation.

A hypocenter ellipsoid is a sphere representing characteristics of an elastic wave that is generated by explosion and propagates in the form of a sphere evenly in the space while rupture occurs. When rupture turns into directional fissures, the generated elastic wave is distorted into an ellipsoid corresponding to the process of fissure formation.

### Embodiment 1

The present disclosure provides a system and a method for spatial, quantitative characterization of a fault/fissure. The present disclosure can further provide a method and a system for ellipsoid fitting for characterization of a fault/fissure. The present disclosure can further provide a method and a system for assessing ellipsoid fitting quality.

The present embodiment provides a processor, which is configured to operate the coding program of the method for spatial, quantitative characterization of a fault/fissure.

In the art known by the inventors, the quality of description of physical characteristics of fissures mainly defined by the quantity and accuracy of collected spatial coordinate data. Thus, unsatisfying data collection can prevent some fissures in a solid object from being accurately described.

The present disclosure creatively uses a three-dimensional fissure ellipsoid that covers fissure vector to describe physical characteristics of fissures. The disclosed method can generate an accurate three-dimensional fissure ellipsoid from spatial coordinate data collected using existing devices, and can provide quantitative description of fissures based on spatial geometric parameters of the fissure ellipsoid. Therefore, the present disclosure advantageously features simple computing and accurate quantitative description of fissures.

The present embodiment operates on the principles explained below.

Multiple sets of spatial coordinate data of a fissure are collected and corresponding spatial coordinate points are linked to form a polyhedron. According to the center of gravity data of the polyhedron, the multiple sets of spatial coordinate data are fit to form a fundamental elliptic equation of a fissure ellipsoid. The three-dimensional fissure ellipsoid corresponding to the fundamental elliptic equation fully covers the center of gravity of the fissure and the multiple sets of spatial coordinate point. This means that the fissure ellipsoid embraces and covers all the relevant spatial structures, including the fissure, structural planes, the fracture zone, weak interlayers, and cavities. For example, the fissure ellipsoid can cover the spatial distribution scope of the fault/fissure; the fissure ellipsoid can cover the spatial distribution scope of the fracture zone. In other words, the spatial geometric parameters of the fissure ellipsoid are associated with the physical characteristics of the fault/fissure provided that the three-dimensional space of the fissure ellipsoid embraces the spatial distribution scope of the fissure. Therefore, the spatial geometric parameters of the fissure ellipsoid can be used to quantitatively account for the geometric and spatial characteristics of the fault/fissure.

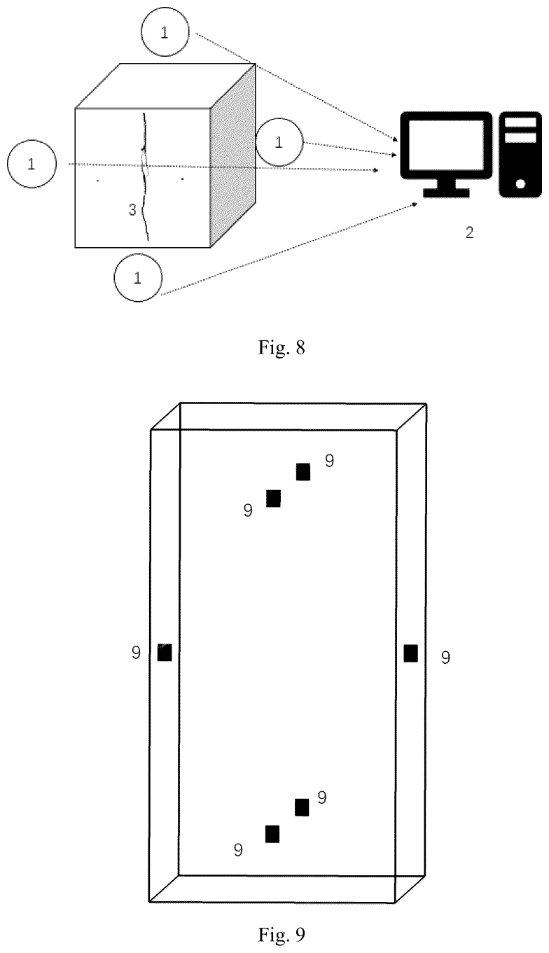

The system for spatial, quantitative description of a fault/fissure according to the present disclosure, as shown in FIG. 8, comprises at least one coordinate collecting component 1 and at least one processor 2. The coordinate collecting components 1 are connected to the processor 2 in a wired and/or wireless manner, so as to send the detected spatial coordinate data of the fault/fissure 3 to the processor 2.

The coordinate collecting components 1 are configured to detect spatial coordinate data of faults, joints, and/or fissures of different sizes in a solid body, such as a rock. Since spatial measurement of fissure structures has been mature, it is easy to obtain spatial coordinate data of fissure structures. The coordinate collecting components are deployed around the fault/fissure to collect spatial coordinate data of the fault/fissures in multiple directions.

After receiving the spatial coordinate data from the coordinate collecting components 1, the processor 2 processes the received data through the following steps.

At S1, it constructs a spatial distribution scope of the fault/fissures 3.

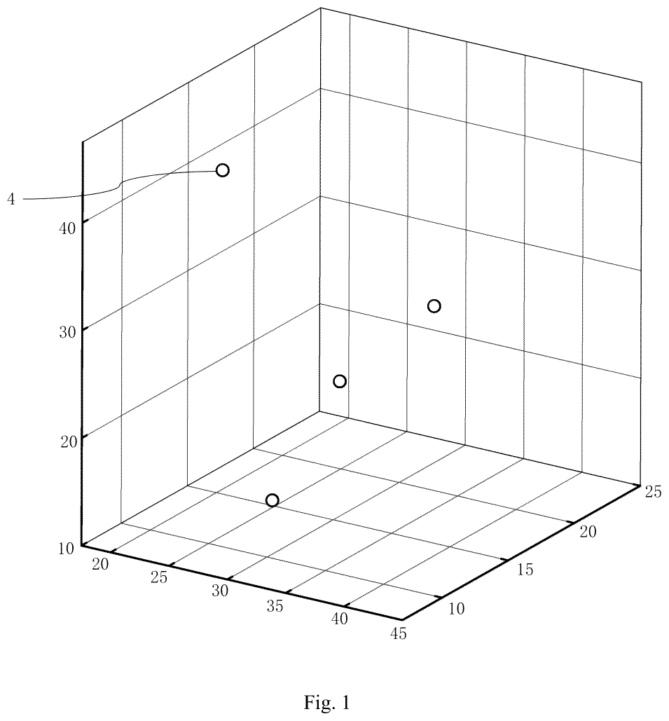

As shown in FIG. 1, the axes x, y, and z in the spatial coordinate system represent three coordinate axes in a space. The spatial coordinate system is used to represent the spatial distribution scope of several fissures, and its origin is user-defined. To construct the spatial distribution scope of the fault/fissures, we need spatial coordinate data from 4 or more coordinate collecting components.

According to the present disclosure, fitting related to the fissure ellipsoid is performed using spatial coordinate data from 4 or more coordinate collecting components because fewer sources of spatial coordinate data provide less data, which degrades coverage of the fissure ellipsoid with respect to the spatial distribution scope of the fissures. Specifically, where the number of sets of the spatial coordinate data is smaller than 4, it is not possible to learn the spatial distribution scope of the fissures, making performance of fitting and formation of the fissure ellipsoid impossible.

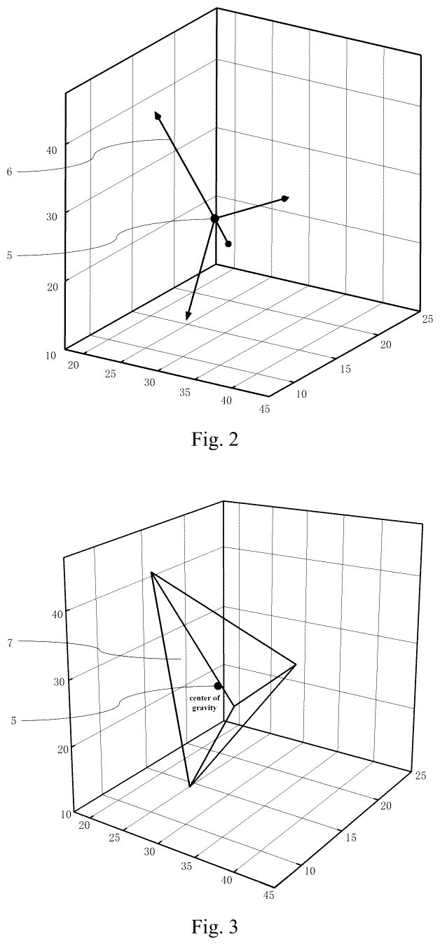

As shown in FIG. 1, in a spatial coordinate system there are 4 spatial coordinate points 4 distributed, which represent 4 sets of spatial coordinate data. As shown in FIG. 3, the 4 spatial coordinate points 4 are linked to form a tetrahedron, which represents the spatial distribution scope of the spatial coordinate data. As shown in FIG. 2 and FIG. 3, the center of gravity of the tetrahedron is the center of gravity 5. The center of gravity 5 is linked to each spatial coordinate point so as to form a fissure vector 6 pointing to the location of the respective spatial coordinate point.

As shown in FIG. 2 and FIG. 3, the tetrahedron in the three-dimensional space has a center of gravity (Cₓ, C_{y}, C_{z}) that is the arithmetic mean of its four vertices (xᵢ, yᵢ, zᵢ).

$${C}_{x} = \frac{1}{4} ( {x}_{1} + {x}_{2} + {x}_{3} + {x}_{4} ) ;$$

$${C}_{y} = \frac{1}{4} ( {y}_{1} + {y}_{2} + {y}_{3} + {y}_{4} ) ;$$

$${C}_{z} = \frac{1}{4} ( {z}_{1} + {z}_{2} + {z}_{3} + {z}_{4} ) .$$

In order to locate the center of gravity of the three-dimensional spatial polyhedron 7, the polyhedron 7 has to be tetrahedrally meshed, and the volume-weighted average of the coordinates of the center of gravity of the tetrahedron is calculated. The polyhedron 7 is divided into n tetrahedrons. The centers of gravity of the tetrahedrons are \vec{C}₁ . . . \vec{C}ₙ, respectively, and the volumes of the tetrahedrons are V₁ . . . Vₙ, respectively. The center of gravity of the polyhedron 7 is:

$$\vec{C} = \frac{{V}_{1} {\vec{C}}_{1} + … + {V}_{n} {\vec{C}}_{n}}{{V}_{1} + … + {V}_{n}} .$$

TABLE 1
Calculation of Center of Gravity of Tetrahedron

| Vertex Coordinates | Center of Gravity Coordinates |
|---|---|
| (21.01, 23.4, 14.75) | ${C}_{x} = \frac{1}{4} ( 21.01 + 28.05 + 29.13 + 41.75 ) = 29.99$ |
| (28.05, 8.26, 46.66) | ${C}_{y} = \frac{1}{4} ( 23.4 + 8.26 + 11.16 + 12.2 ) = 13.76$ |
| (29.13, 11.16, 14.24) | ${C}_{z} = \frac{1}{4} ( 14.75 + 46.66 + 14.24 + 34.76 ) = 27.6$ |
| (41.75, 12.20, 34.76) | C = (29.99, 13.76, 27.60) |

Table 1 exhibits calculation of the center of gravity for a tetrahedron. The spatial coordinate points of the four points on the spatial boundary of 1 fissure are (21.01, 23.4, 14.75), (28.05, 8.26, 46.66), (29.13, 11.16, 14.24), and (41.75, 12.20, 34.76), respectively. Then the spatial coordinates of the center of gravity of the tetrahedron is (29.99, 13.76, 27.60). Then the center of gravity is connected to the four points on the spatial boundary of the fissure to obtain the fissure vectors.

At S2, a sphere covering the fissure vectors is constructed.

As shown in FIG. 3, a sphere or ellipsoid is set to embrace the spatial distribution scope of the fissure vectors.

Preferably, a polyhedron is constructed with multiple points on the spatial boundary of a fissure. Then the center of gravity of the polyhedron is determined by cutting. With the gravity of center of the polyhedron, fissure vectors are constructed and then a sphere of ellipsoid is fitted through the fissure vectors.

At S3, the specific form of the ellipsoid equation is obtained through calculation.

Preferably, based on the quantity of the spatial coordinate data, the way to fit the coefficient of the fundamental elliptic equation is determined.

If the quantity of the received spatial coordinate data is not smaller than a predetermined data threshold, the coefficient of the fundamental elliptic equation is determined through fitting directly.

If the quantity of the received spatial coordinate data is smaller than the predetermined data threshold, the coefficient of the fundamental elliptic equation is fit after random interpolation is performed around the principal plane of a hypothetical fissure ellipsoid estimated through the fissure vectors.

The data threshold is preferably 10. To be specific, when the number of sets of the spatial coordinates is smaller than 10, random interpolation has to be performed, and when the number of sets of the spatial coordinates is greater than or equal to 10, random interpolation is not necessary.

In the present disclosure, the data threshold is not limited to 10, and may alternatively be 8, 9, 11, or 12. According to experiments conducted, the data threshold set at 10 is enough to satisfy the need of fitting for the fissure ellipsoid. When the data threshold is smaller than 10, such as 9, the fitting quality of the fissure ellipsoid obtained using currently available spatial coordinate data without interpolation can be poor. Preferably, the more the data of spatial coordinates are, the better fitting effect could be achieved. Preferably, the data should be distributed spatially as much as possible in the fissure space to obtain a better fitting effect.

After extensive analysis of spatial coordinate data and fitting quality, the inventors of the present disclosure found that 10 would be appropriate for the data threshold.

Where the quantity of the received spatial coordinate data is not smaller than the predetermined data threshold (e.g., 10), the coefficient of the fundamental elliptic equation for the fissure ellipsoid is calculated as described in the steps S31˜S32.

At S31, the coefficient of the ellipsoid equation is determined based on the collected spatial coordinate data.

The fundamental elliptic equation may be expressed as:

$$F ( x , y , z ) = {a}_{11} {x}^{2} + {a}_{22} {y}^{2} + {a}_{33} {z}^{2} + 2 {a}_{12} x y + 2 {a}_{13} x z + 2 {a}_{23} y z + 2 {a}_{14} x + 2 {a}_{24} y + 2 {a}_{34} z + {a}_{44} \qquad ( 1 )$$

In the fundamental elliptic equation, x, y, z coordinates represent spatial coordinates of a corresponding fissure on the sphere, with a size obtained by multiplying the fissure vector by the direction cosine, respectively. Therein, a denotes the coefficient, which is the coefficient of the fundamental elliptic equation (1) obtained through fitting from the spatial coordinate data collected by the coordinate collecting components.

Spatial geometric parameters of the fissure ellipsoid include its center, axis lengths, focal-point coordinates, etc. However, these spatial geometric parameters cannot be determined directly from the fundamental elliptic equation (1) of the fissure ellipsoid and thus the fundamental elliptic equation (1) has to be modified into the standard form.

At S32, the fundamental elliptic equation is modified into the standard form for the ellipsoid.

Preferably, fitting is performed using the least squares method so as to obtain the coefficient of the fundamental elliptic equation. Preferably, other methods such as KKT (Karush-Kuhn-Tucker) conditions, lagrangian method, AI algorithms, machine learning, deep learning, could be used to obtain the coefficient of the fundamental elliptic equation.

The standard form of the ellipsoid may be expressed as:

$$F ( x , y , z ) = \frac{{( x - {x}_{0} )}^{2}}{{a}^{2}} + \frac{{( y - {y}_{0} )}^{2}}{{b}^{2}} + \frac{{( z - {z}_{0} )}^{2}}{{c}^{2}} - 1 \qquad ( 2 )$$

where x₀, y₀, z₀ represent the coordinates of the center of the ellipsoid, and a, b, and c represent the semi-major, semi-median, and semi-minor axes of the ellipsoid, respectively.

Coefficients of the fundamental elliptic equation can be simplified into the form below:

$$A = \{ \begin{matrix}{a}_{11} & {a}_{12} & {a}_{13} & {a}_{14} \\ {a}_{12} & {a}_{22} & {a}_{23} & {a}_{24} \\ {a}_{13} & {a}_{23} & {a}_{33} & {a}_{34} \\ {a}_{14} & {a}_{24} & {a}_{34} & {a}_{44}\end{matrix} \} , A *= \{ \begin{matrix}{a}_{11} & {a}_{12} & {a}_{13} \\ {a}_{12} & {a}_{22} & {a}_{23} \\ {a}_{13} & {a}_{23} & {a}_{33}\end{matrix} \} , \qquad ( 3 )$$

$${K}_{3} = \vert A \vert , {I}_{3} = \vert A * \vert$$

where I₃ represents the third invariant in Matrix A*, and K₃ represents the third semi-invariant of A, with values thereof being determinants corresponding to the matrix.

Moreover, the eigenvalues (λ₁, λ₂, λ₃) and the unit eigenvectors (η₁, η₂, η₃) corresponding to A* can be also obtained.

Based on the aforementioned parameters, the center X_{c}=(x_{c}, y_{c}, z_{c}), lengths of semi axes (a, b, c), and linear eccentricity (pseudo) of the ellipsoid can be obtained as:

$${X}_{c}^{T} = - {{( {A}^{*} )}^{-} [ \begin{matrix}{a}_{14} & {a}_{24} & {a}_{34}\end{matrix} ]}^{T} \qquad ( 4 )$$

$$a = \sqrt{\vert \frac{{K}_{3}}{{λ}_{1} {I}_{3}} \vert} , b = \sqrt{\vert \frac{{K}_{3}}{{λ}_{2} {I}_{3}} \vert} , c = \sqrt{\vert \frac{{K}_{3}}{{λ}_{3} {I}_{3}} \vert} \qquad ( 5 )$$

$${C}_{0} = \sqrt{{a}^{2} - {b}^{2}} \qquad ( 6 )$$

The direction corresponding to the first axis (or the major axis) of the fissure ellipsoid is determined by the eigenvector η₁. The focus of the ellipsoid is on the major axis, and its coordinates can be calculated from the coordinates of the center of sphere. As such, all the spatial geometric parameters of the fissure ellipsoid have been obtained.

With the center of gravity 5 being the focus on the major axis of the fissure ellipsoid, the spatial geometric parameters of the fissure ellipsoid are right the physical characteristics parameters of the fissure. In other words, the fissure can be quantitatively characterized using the parameters of the fissure ellipsoid.

In the present disclosure, the first axis direction of the fissure ellipsoid is the direction of the greatest fissure vector. The principal plane is determined according to the first axis. In the principal plane, the first axis and the second axis are perpendicular to each other. The projection of the direction of the greatest fissure vector on the second axis indicates the size of the second axis. The third axis is perpendicular to each of the first axis and the second axis. Preferably, aperture of the fault fissure can be described using the third axis parameter of the fissure ellipsoid. Based on the area of the principal plane of the fissure ellipsoid, the spatial size of the fault fissure can be described. Based on the normal direction of the principal plane of the fissure ellipsoid, the spatial orientation of the fault fissure can be expressed.

The fissure ellipsoid is highly adaptable to cover various joints, fissures, faults, structural planes, fracture zones, and weak interlayers.

In addition to covering the fault/fissure as described previously, the fissure ellipsoid disclosed in the present disclosure may provide coverage to the spatial distribution scope defined by several fissures in other scenarios.

Firstly, for a single fault/fissure, the fissure ellipsoid can directly cover it.

Secondly, for joints distributed regularly, a suitable spatial distribution scope is selected and then covered using the fissure ellipsoid.

Thirdly, for fissures of significantly different sizes, the fissure ellipsoid can fully cover the main fissure while covering most of the other small fissures.

Fourthly, for other structural planes in a rock, such as dense fracture zones (cleavage zones), fault fracture zones, metamorphic structural planes, sedimentary structural planes, and weak interlayers, the same processing method applies.

In sum, various structural planes that have been geologically determined can be expressed quantitatively in the form of tensor using the disclosed fissure ellipsoid. A space ellipsoid can be represented by a tensor that does not depend on the coordinate system, called a fissure tensor. The fissure tensor could participate in quantitative calculations related to physical and mechanical processes. The present disclosure can be directly applied to constitutive relations to facilitate quantitative calculation in the field of mechanics or enable numerical simulation.

At S4, the coefficient of the fundamental elliptic equation (1) is calculated.

Preferably, where the quantity of the spatial coordinate data is greater than or equal to 10, the processor does not need to make random interpolation in the principal plane of the fissure ellipsoid. When receiving fissure data collected by 9 or more coordinate collecting components (i.e., 9 sets of coordinates), it is possible to figure out the coefficient of the fundamental elliptic equation (1) through fitting using the least squares method.

At S5, the spatial geometric parameters of the fissure ellipsoid are calculated.

Preferably, the processor calculates the spatial geometric parameters of the fissure ellipsoid using on the least squares method as shown below:

$$min G ( A ) = \frac{4 π ( a b + b c + a c )}{3} \qquad ( 7 - 1 )$$

where min G (A) represents the objective function; a represents length of the semi-major axis; b represents the length of the semi-median axis; and c represents the length of the semi-minor axis.

With the objective function set as the ellipsoid volume of the fissure ellipsoid,

$$min {G}^{′} ( A ) = \frac{4 π abc}{3} \qquad ( 7 - 2 )$$

where min G′ (A) represents the ellipsoid volume.

The previous equation after further simplified is equivalent to:

$$min {G}^{′′} ( A ) = - \vert {I}_{3} \vert \qquad ( 7 - 3 )$$

where min G″ (A) represents the ellipsoid volume, I₃=|A*|.

The first constraint is the n linear equations, or n fundamental elliptic equations, constructed using the fissure vectors. At this time the variable is the element of Matrix A, and x, y, and z represent the spatial coordinates, so:

$${a}_{11} {x}^{2} + {a}_{22} {y}^{2} + {a}_{33} {z}^{2} + {a}_{12} x y + {a}_{13} x z + {a}_{23} y z + {a}_{14} x + {a}_{24} y + {a}_{34} z + {a}_{44} = 0 \qquad ( 8 )$$

The second constraint is the coefficient condition of the ellipsoid equation in the standard form, which is:

$$\frac{{K}_{3}}{{λ}_{1} {I}_{3}} > \frac{{K}_{3}}{{λ}_{2} {I}_{3}} > \frac{{K}_{3}}{{λ}_{3} {I}_{3}} > 0 \qquad ( 9 )$$

The third constraint is the condition of the solution of the characteristic equation of the quadratic term coefficient matrix of the ellipsoid equation, namely the condition that a one variable cubic equation has three real roots, so:

$$Δ = 4 {{I}_{1}}^{3} {I}_{3} - {{I}_{1}}^{2} {{I}_{2}}^{2} - 18 {I}_{1} {I}_{2} {I}_{3} + 27 {{I}_{3}}^{2} \leq 0 \qquad ( 10 )$$

where I₁ represents the first invariant of Matrix A*; I₂ represents the second invariant of Matrix A*; and I₃ represents the third invariant of Matrix A*.

The fourth constraint is the condition of the focus. The source coordinates (x_{c}, y_{c}, z_{c}) are identical to the focus coordinates obtained from the lengths of the semi-axes and the linear eccentricity through calculation, which is expressed as:

$${x}_{c} = {x}_{0} - {C}_{0} {η}_{1} ( 1 ) , {y}_{c} = {y}_{0} - {C}_{0} {η}_{1} ( 2 ) , {z}_{c} = {z}_{0} - {C}_{0} {η}_{1} ( 3 ) \qquad ( 11 )$$

where x₀, y₀, z₀ represents the center coordinates of the fissure ellipsoid; C₀ represents the linear eccentricity; and η₁ represents the unit principal vector in the principal axis direction. In this equation, (1), (2), and (3) represent that there are 3 direction vectors, and each direction vector is represented by 3 components.

If the number of sets of the spatial coordinate data is smaller than 10, the processor makes random interpolation in the principal plane of the fissure ellipsoid through the following steps.

S51 involves determining the principal plane.

As shown in FIG. 19, the direction of the greatest fissure vector is taken as the first principal direction of the fissure ellipsoid, and the greatest fissure vector mode is taken as the maximum radiation of the major axis, i.e., \vec{B}ₘₐₓ. Then the cross product of each of the other fissure vectors and the direction of the greatest fissure vector is calculated, and the maximum of the mode of \vec{C}ᵢ is the fissure vector \vec{B}ₘₐₓ corresponding to max∥\vec{C}ᵢ∥. The unit vector obtained by calculating the cross product of the fissure vector \vec{B}ₘₐₓ and the direction of the greatest fissure vector is the normal direction of the principal plane, i.e.,

$${\vec{N}}_{1} = \frac{{\vec{C}}_{max}}{‖ {\vec{C}}_{max} ‖} .$$

By determining the normal direction of the principal plane, the principal plane is determined. \vec{C}ᵢ represents each of the fissure vectors; \vec{C}ₘₐₓ represents the fissure vector \vec{C}ᵢ having the greatest mode, and ∥\vec{C}ₘₐₓ∥ represents the mode of \vec{C}ₘₐₓ. The direction perpendicular to the first axis in the principal plane is the second axis direction. The size of the projection of the fissure vector \vec{B}ₘₐₓ on the second axis is the size of the second axis, i.e.,

$${\vec{B}}_{⊥} = \frac{max ‖ {\vec{C}}_{i} ‖}{‖ {\vec{B}}_{max} ‖} .$$

Therein, \vec{B}_{⊥} represents the size of the second axis.

S52 is about making points randomly.

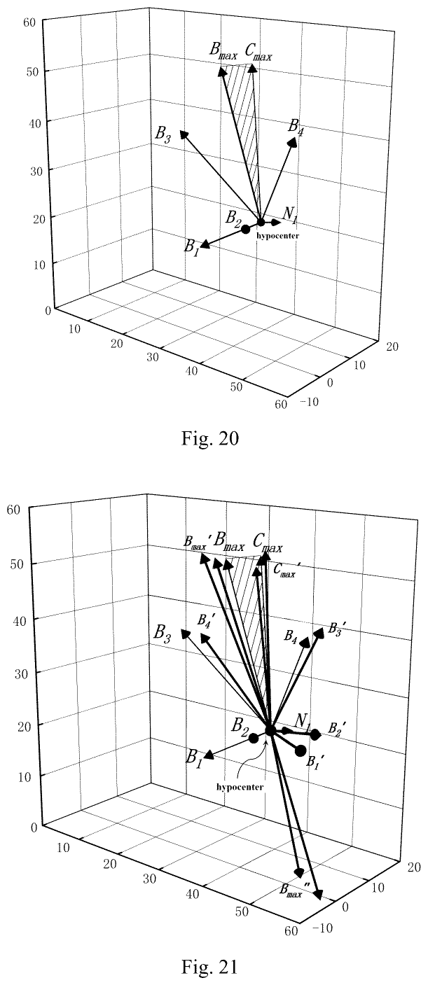

As shown in FIG. 20, 2 points are made randomly within a range of 5 degrees apart from the first principal direction at one side and sized 0.9˜1.1\vec{B}ₘₐₓ. Then, 2 points are made randomly within a range of 15 degrees apart from the first principal direction at the other side and sized 0.9˜0.1\vec{B}ₘₐₓ. At last, 2 points are made randomly along the second principal direction and sized 0.9˜1.1\vec{B}_{⊥}.

Except for the two fissure vectors of the determined principal plane, for all the fissure vectors, points are made in a mirroring manner. Each fissure vector and the normal direction of the principal plane define an included angle sized α. When the included angle α is smaller than

$$\frac{π}{2} ,$$

the point is made in the direction that works with the fissure vector to define an included angle of π−2α, and the point is sized 0.9˜1.1\vec{B}_{⊥}. When the included angle is greater than

$$\frac{π}{2} ,$$

the point is made in the direction that works with the fissure vector to define an included angle of 2α−π, and the point is sized 0.9˜1.1\vec{B}ᵢ.

At S53, the fitting quality is assessed.

The fitting quality is determined better when the area of the fissure ellipsoid is smaller and covers more fissure vectors.

Specifically, the fissure ellipsoid formed through fitting is coupled with each fissure vector equation and the intersection between the two is found. The root of the sum of squares of residuals between individual fissure vectors and the intersection is extracted and then divided by the number of the spatial coordinate points so as to obtain the average coverage difference with respect to the fissure vectors. The average coverage difference is then divided by the sum of the fissure vector modes and multiplied by the percentage to produce the value of the coverage difference ratio. At last, by subtracting the value from 1, the coverage ratio of the fissure ellipsoid can be determined. The greater the coverage ratio of the fissure ellipsoid is, the better the fitting quality is.

By randomly adding points in the principal plane as described previously, the present disclosure makes most average coverage differences below 10 mm.

For example, the ellipsoid may be expressed as:

$$F ( x , y , z ) = {a}_{11} {x}^{2} + {a}_{22} {y}^{2} + {a}_{33} {z}^{2} + {a}_{12} xy + {a}_{13} xz + {a}_{23} yz + {a}_{14} x + {a}_{24} y + {a}_{34} z + {a}_{44} = 0.$$

Assuming that the center of gravity of the spatial polyhedron 7 is located at the coordinates M₀(x₀, y₀, z₀) and the vertex of the fissure vector \vec{B}ᵢ=(m, n, p), is located at the coordinates (x₂, y₂, z₂), with the M(x, y, z) being an arbitrary point in the fissure vector, the fissure vector equation is

$$\frac{x - {x}_{0}}{m} = \frac{y - {y}_{0}}{n} = \frac{z - {z}_{0}}{p} .$$

The fissure ellipsoid is coupled with the fissure vector equation and the intersection M₁(x₁, y₁, z₁) between the two can be found.

The residual (distance) between the fissure vector and the intersection is dᵢ=\sqrt{(x₂−x₁)²+(y₂−y₁)²+(z₂−z₁)²}.

The average coverage difference of the fissure vectors is

$$D = \frac{\sqrt{{\sum }_{i = 1}^{n} {d}_{i}^{2}}}{n} .$$

The sum of the fissure vector modes is A=Σᵢ₌₁ⁿAᵢ, and the coverage ratio of the fissure ellipsoid is

$$( 1 - \frac{D}{A} ) * 100 \% .$$

At S6, based on the fit fissure ellipsoid, the fault/fissure can be quantitatively characterized.

The present disclosure uses the least squares method to perform fitting for the fissure ellipsoid on the basis of the greatest fissure, so it can determine the spatial geometric parameters of the fissure ellipsoid uniquely. In the fissure ellipsoid, the first axis direction represents the direction of the greatest fissure vector. The principal plane refers to the plane in which first axis and the second axis are present. The second axis is perpendicular to the first axis in the principal plane. The direction perpendicular to the first axis direction in the principal plane is the second axis direction. The axis perpendicular to the first axis and the second axis is the third axis.

Based on the third axis parameter of the fissure ellipsoid, the width-related geometric characteristics of the defects of the solid structure can be described. Based on the area and/or normal direction of the principal plane of the fissure ellipsoid, the spatial characteristics of the defects of the solid structure can be described. Specifically, based on the area of the principal plane of the fissure fundamental elliptic equation, the spatial size of the fault/fissure can be described. Based on the normal direction of the principal plane of the fissure ellipsoid, the spatial orientation of the fault/fissure can be described. Thereby, the present disclosure uses the geometric characteristics of the spatial fissure ellipsoid to learn the physical characteristics of the fissures. The calculation is simple and the physical process is clear and intuitive. Even people without professional background can easily understand.

### Embodiment 2

The present embodiment provides a method for spatial and quantitative description of characteristics of a fault/fissure. The method at least comprises:
collecting spatial coordinate data of the fault/fissure;
according to the spatial coordinate data, determining characteristics of the fault/fissure;
based on spatial coordinate data, constructing a fundamental elliptic equation that covers the spatial distribution scope of the fissure;
characterizing the fault/fissure based on the spatial geometric parameters of the fundamental elliptic equation.

Preferably, the fault/fissure is characterized at least through the following process.

Firstly, based on the third axis parameter of the fissure ellipsoid, the geometric characteristics of the fault and/or fracture zone related to the width are described. For example, based on the third axis parameter of the fissure ellipsoid, the aperture and width of the fault/fissure are described. Or, based on the third axis parameter of the fissure ellipsoid, the aperture and width of the fracture zone are described. The method can be further used to describe the aperture and/or width, such as of a dense fracture zone (cleavage zone), a fault fracture zone, a metamorphic structural plane, a sedimentary structural plane, and/or a weak interlayer.

Secondly, based on the area and/or normal direction of the principal plane of the fissure ellipsoid the spatial characteristics of the fault/fissure are described.

Specifically, based on the area of the principal plane of the fissure ellipsoid, the spatial size of the fault/fissure is described. Based on the normal direction of the principal plane of the fissure ellipsoid, the spatial orientation of the fault/fissure is described.

According to the present disclosure, the fissure ellipsoid may characterize a fault/fissure in a way other than the three described previously and may be used to describe other characteristics of a fault/fissure.

Preferably, constructing the fundamental elliptic equation for the fissure ellipsoid that covers the spatial distribution scope of the fissure based on the spatial coordinate data is achieved at least through:
based on the quantity of the spatial coordinate data, determining how the coefficient of the fundamental elliptic equation with respect to the fissure is fit. Based on the coefficient of the fundamental elliptic equation with respect to the fissure, the spatial geometric parameters of the fissure ellipsoid can be determined.

The step of, based on the quantity of the spatial coordinate data, determining how the coefficient of the fundamental elliptic equation with respect to the fissure is fit at least comprises:
where the quantity of the received spatial coordinate data is not smaller than a predetermined data threshold, directly determining the coefficient of the fundamental elliptic equation through fitting, and where the quantity of the received spatial coordinate data is smaller than the predetermined data threshold, fitting the coefficient of the fundamental elliptic equation by performing random interpolation in the principal plane of the fissure ellipsoid, wherein the data threshold is 10.

Preferably, the step of fitting the coefficient of the fundamental elliptic equation by performing random interpolation in the principal plane of the fissure ellipsoid at least comprises: using the greatest fissure vector of the fissure ellipsoid as the first principal direction of the fissure ellipsoid to determine the principal plane of the fissure ellipsoid; making points in a predetermined angular range in each of the first principal direction and the direction reverse to the first principal direction; randomly making points in the second principal direction; based on the included angle between the fissure vector and the principal plane, determining the point-making direction and making points in a mirroring manner for the fissure vectors not belonging to the principal plane; and fitting and calculating the average coverage ratio of the fissure vectors.

Preferably, the ellipsoid fitting quality is determinized based on the average coverage ratio of the fissure ellipsoid with respect to the fissure vectors. With the fitting quality satisfying, the fault/fissure is characterized based on the spatial geometric parameters of the fundamental elliptic equation.

### Embodiment 3

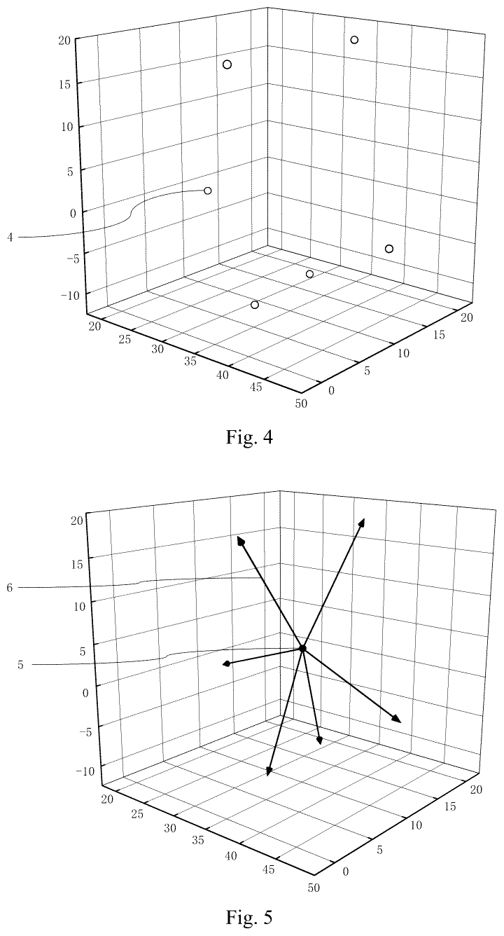

In the present embodiment, fissure ellipsoid fitting is further explained with an example wherein 6 sets of spatial coordinate data are used to characterize a fissure, as shown in FIG. 4˜FIG. 7. Calculation processes similar to those described with reference to Embodiment 1 are not repeated herein. The tetrahedrons shown in Table 2 are tetrahedrons formed by dividing the hexahedron.

TABLE 2
Calculation of Center of Gravity of Hexahedron

| | Coordinate of Center | | Coordinates of |
|---|---|---|---|
| | of Gravity of | | Center |
| Vertex Coordinates | Tetrahedron | Volume of Tetrahedron | of Gravity |
| (32.40, 7.40, −11.39) (36.33, 0.72, 18.86) | (30.24, 8.76, −1.01) | 563.15 | $C = \frac{{V}_{1} {\vec{C}}_{1} + … + {V}_{n} {\vec{C}}_{n}}{{V}_{1} + … + {V}_{n}} = ( 34.08 , 10.86 , 3.87 )$ |
| (32.33, 15.35, −10.47) | (30.73, 11.81, 6.36) | 1233.92 | |
| (34.37, 19.61, 18.11) | (37.14, 8.77, −1.37) | 578.09 | |
| (47.48, 11.62, −2.50) | (37.63, 11.82, 6.00) | 1274.87 | |
| (19.89, 11.57, −1.07) | | | |

As shown in FIG. 4 and Table 2, six sets of spatial coordinate data of the fault/fissure collected by the spatial coordinate collecting components 1 are (32.40, 7.40, −11.39), (36.33, 0.72, 18.86), (32.33, 15.35, −10.47), (34.37, 19.61, 18.11), (47.48, 11.62, −2.50), and (19.89, 11.57, −1.07), respectively.

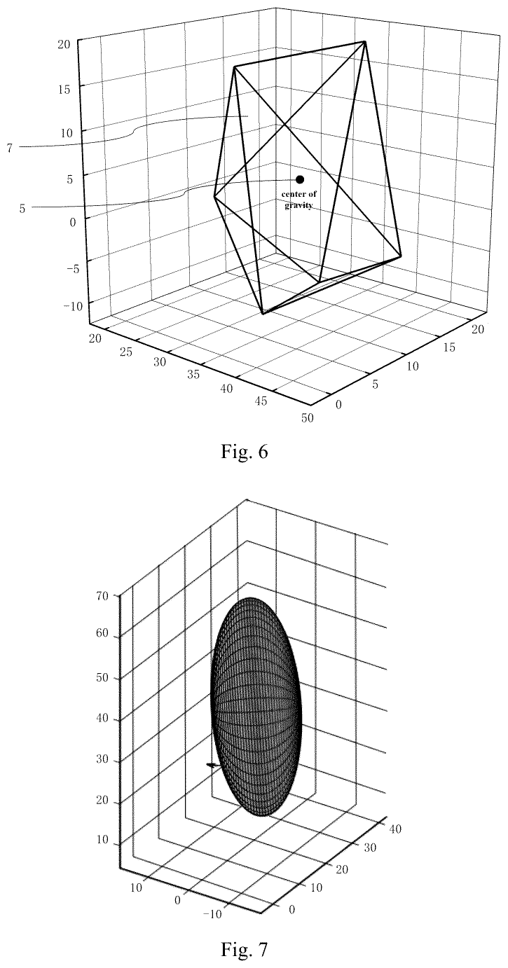

As shown in FIG. 6, the six spatial coordinate points are linked to form a hexahedron. The hexahedron is divided into four tetrahedrons. The centers of the four tetrahedrons are (30.24, 8.76, −1.01), (30.73, 11.81, 6.36), (37.14, 8.77, −1.37), and (37.63, 11.82, 6.00), respectively, as determined through calculation. The volumes of the four tetrahedrons are 563.15, 1233.92, 578.09, and 1274.87, respectively, as determined through calculation. Based on the centers of gravity and the volumes of the four tetrahedrons, the spatial coordinate of the center of gravity 5 of the hexahedron can be calculated as:

$$C = \frac{{V}_{1} {\vec{C}}_{1} + … + {V}_{n} {\vec{C}}_{n}}{{V}_{1} + … + {V}_{n}} = ( 34.08 , 10.86 , 3.87 ) .$$

As shown in FIG. 5, the center of gravity 5 and the six spatial coordinate points 4 are linked with the linking line pointed to the corresponding spatial coordinate points, so as to form six fissure vectors 6.

Since the number of the spatial coordinate point is smaller than 10, random interpolation is implemented to calculate the coefficient of the fundamental elliptic equation. As shown in FIG. 7, after the coefficient of the fundamental elliptic equation is determined through calculation, fitting for the fissure ellipsoid is performed in the three-dimensional spatial coordinate system. As shown in FIG. 7, the three-dimensional fissure ellipsoid covers most of the fissure vectors. The average coverage ratio of the fissure ellipsoid for the fissure vectors is calculated as shown in Table 3.

TABLE 3
Calculation of coverage ratio of Fissure Ellipsoid with 6 Spatial Coordinate Points

| Vertex Coordinates of | Fissure Vector | Intersection M? between | Residual (Distance) |
|---|---|---|---|
| Fissure Vector | Mode | Fissure Vector and Ellipsoid | Dᵢ |
| (21.87, 13.34, 52.49) | 27.04 | (20.24, 11.71, 50.85) | 8.01 |
| (23.71, 17.25, 17.39) | 16.97 | (19.66, 8.64, 26.45) | 13.13 |
| (21.95, 4.49, 53.37) | 28.48 | (20.18, 7.08, 34.78) | 18.86 |
| (24.63, 0.54, 15.320) | 21.44 | (25.41, −0.60, 13.58) | 2.22 |
| (6.14, 9.42, 42.71) | 18.15 | (18.10, 8.30, 28.53) | 18.58 |
| (37.64, 9.26, 40.67) | 21.61 | (27.57, 8.66, 33.07) | 12.63 |
| Residual | Average | | Coverage Ratio |
| Sum of | Coverage | Sum of Fissure | of Fissure |
| Squares | Difference | Vector Mode | Ellipsoid |
| 8.01² + 13.13² + 18.86² + 2.22² + 18.582 + 12.632 = 1102.12 | $\frac{\sqrt{1102.12}}{6} = 5.533$ | 27.04 + 16.97 + 28.48 + 21.44 + 18.15 + 21.61 = 115.54 | $( 1 - \frac{5.533}{115.54} ) * 100 \% = 95.21 \%$ |

Table 3 shows the coverage ratio and related parameters of the fissure ellipsoid with respect to fissure vectors based on the spatial coordinate data of six fissures. The average coverage difference is 5.533, and the coverage ratio of the fissure ellipsoid is 95.21%, indicating that the fitting quality of the fissure ellipsoid is satisfying. With the fitting quality of the fissure ellipsoid determined as satisfying, the fissures can be characterized using the spatial geometric parameters of the fundamental elliptic equation.

Table 4 shows the spatial geometric parameters of one fundamental elliptic equation for the fissure ellipsoid according to the present disclosure. As shown in Table 4, the third axis parameter of the fissure ellipsoid is 2.18, meaning that the aperture representing the fault and/or fracture zone is 2.18 mm. The area of the principal plane based on fundamental elliptic equation is 87.55, meaning that the spatial size of the fissure is −87.55 mm². The normal vector of the principal plane of the fissure ellipsoid is (−0.96, −0.085, 0.26), meaning that the coordinate set of spatial orientation of the fissure is (−0.96, −0.085, 0.26).

TABLE 4
Spatial Geometric Parameters of Fissure Ellipsoid

| | | | | | Normal |
|---|---|---|---|---|---|
| | | | Center | Area of | Vector of |
| | Unit Vector | Axis | Coordinate | Principal | Principal |
| | of Axis | Length | of Ellipsoid | Plane | Plane |
| Major | (0.17, −0.93, | 12.07 | (30.61, 15.17, | S = Π * ab = | (−0.96, |
| Axis | 0.32) | | 14.15) | 3.14 * 12.07 * | −0.085, |
| Median | (0.22, 0.35, | 2.31 | | 2.31 = 87.55 | 0.26) |
| Axis | 0.91) | | | | |
| Minor | (0.96, 0.08, | 2.18 | | | |
| Axis | −0.26) | | | | |

As shown above, the present disclosure uses the spatial coordinate data of six fissures to fit and form a fissure ellipsoid and the fitting quality of the fissure ellipsoid is satisfying as measured by the average coverage ratio. With the fissure ellipsoid having satisfying fitting quality, the present disclosure can provide quantitative description of physical characteristics of the fissures.

The present disclosure can accurately characterize fissures and fracture zones thereof independent of the accuracy of collected spatial coordinate data of fissures.

### Embodiment 4

The present disclosure provides a system and a method for characterizing fault/fissure hypocenters based on waveform characteristics. The present disclosure may further provide a method and a system for calculating hypocenter energy.

The system of the present disclosure comprises plural elastic-wave collecting components 9 and at least one processor 2. The elastic-wave collecting components 9 and the processor 2 are connected in a wired and/or wireless manner. The wired manner may be implemented by communication connection through optical fibers and the wireless manner may be implemented by wireless communication connection through Bluetooth communication components, WIFI communication components, ZigBee communication components, IR communication components, or the like.

The elastic-wave collecting components 9 collects elastic waves of a hypocenter 10. The elastic-wave collecting components 9 are preferably wideband vibration sensors, with a frequency range of 0-2 kHz (low frequency) or 2 kHz-500 kHz (high frequency), depending on the object to be monitored. Exemplarily, for a high-frequency application, the sensor may be R6 piezoceramic sensor or a W800 piezoceramic sensor, and for a low-frequency application, the sensor may be an all-fiber micro-seismic probe.

Preferably, the processor refers to an application-specific integrated circuit and/or server, a CPU, a single-chip microcomputer or the like that is capable of operating the program of the method of the present disclosure for characterizing fault/fissure hypocenters based on waveform characteristics. Preferably, the processor may be integration of plural microprocessors. Preferably, the processor is not limited to a single processing element, and may alternatively be a device containing a processing element and having processing capability, like a server or a computer.

In the known methods, ellipsoids derived from elastic waves through calculation can only characterize static fissure structures and full coverage for fissures usually need plural ellipsoids. Therefore, the known methods are incapable of fast and intuitively characterizing hypocenters of fault/fissures based on waveform characteristics. The present disclosure optimizes calculation of ellipsoids and thereby provides a new, quick and intuitive way to characterize a fault/fissure hypocenter based on a fundamental elliptic equation, so as to improve accuracy of quantitative description and characterization of the hypocenter.

Opposite to the known methods that only characterize some static states of fissures, the present disclosure constructs a new fundamental elliptic equation on the basis of waveform features to provide dynamic description of the fracturing process of a hypocenter. Instead of focusing on dynamic variation of fissures, the present disclosure characterizes the fissure process of the hypocenter itself. The present disclosure uses a hypocenter ellipsoid to characterize the fracturing process of a hypocenter by describing the rupture velocity and the rupture length. The ratio between the rupture length and the rupture velocity is the rupture duration. The present disclosure can further use the volume of the hypocenter ellipsoid to express the energy level of the hypocenter and accordingly determine the rupture magnitude. For example, for a hypocenter that is an earthquake epicenter, the rupture magnitude can be quantified using the volume of the hypocenter ellipsoid.

Currently, the Richter magnitude scale is an extensively used scale which is the size of the earthquake at the source calculated through a certain formula, considering the attenuation of seismic waves from the source to the observation point, based on the amplitude and period of seismic waves observed at a certain distance from the epicenter. The Richter magnitude scale contains 12 magnitudes. The stronger an earthquake is, the number representing the magnitude is greater. An increase of one magnitude corresponds to about 32 times increase in the amount of energy released by the earthquake. The moment magnitude scale uses the size of the seismic moment to determine magnitudes. A seismic moment is a physical quantity describing mechanical magnitude happening during an earthquake (similar to torque), and is determined using a product of the rupture area, the average slip, and the rock shear modulus of an earthquake fault. The seismic moment and the moment magnitude may be obtained through combined inversion of a seismic wave spectra, or obtained from rupture characteristics of the earthquake (the fault scale, the hypocenter depth, the slip amount, and rock mechanical properties related to the earthquake). The known methods using the Richter magnitude scale or the moment magnitude scale to measure earthquakes have their defects as their determination of magnitude is not obtained by directly calculating the energy level of the hypocenter, and for a hypocenter of 8 or higher magnitude, the representation of energy increase is relatively insensitive.

The present disclosure can determine the absolute value of energy and use the absolute energy value to make objective representation of the magnitude of an earthquake. When the magnitude of an earthquake is 8 or higher, the present disclosure can determine the magnitude of an earthquake and its variation directly using the absolute value of the energy of the hypocenter, thereby being more objective and more accurate.

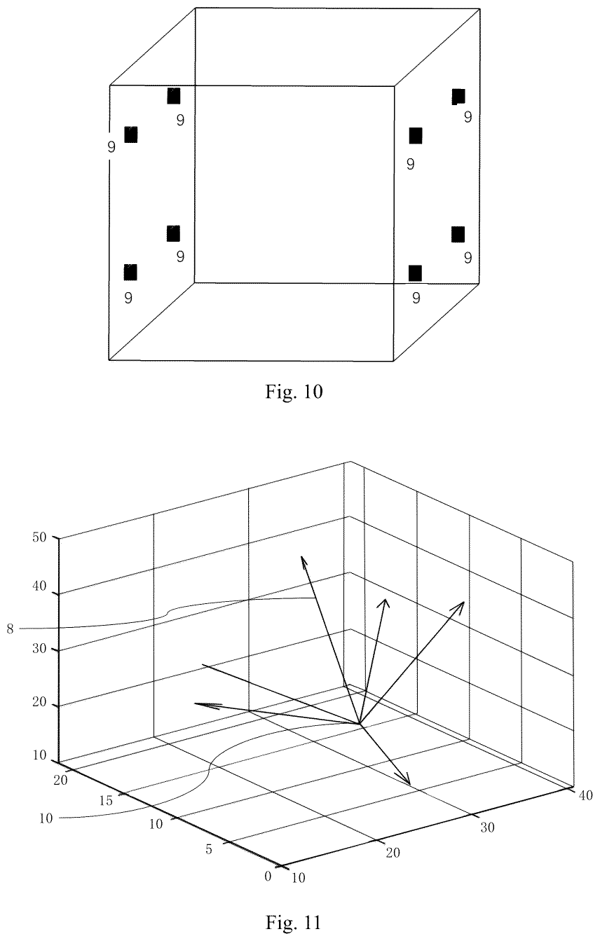

As shown in FIG. 9 and FIG. 10, plural elastic-wave collecting components 9 are deployed over a rock. Assuming that the rock is of a cubic geometric structure, the elastic-wave collecting components 9 may be installed at the surface of the rock and/or around the rock in an arrangement of central symmetry. In the present embodiment, the cubic geometric structure is an ideal structure, and is an exemplary structure. In practical applications, the solid object of interest, such as a rock, may be of a regular, cubic shape, or may be of an irregular, polyhedron shape. In the latter case, the plural elastic-wave collecting components 9 are preferably arranged as close to central symmetry as possible, so as to facilitate collection of elastic waves emitted by fissures inside the rock and propagating outward in different directions. The elastic waves propagate outward and form a radiance field.

In an elastic wave, the longitudinal wave and the transverse wave are both body waves. The energy at the point source propagates outward from the hypocenter 10 in a spherical form, which means the energy level and displacement are equal in all directions. Such a hypocenter is known as an acoustic monopole. The energy and displacement of a fissure hypocenter in all directions during fracture propagation process distort into a hypocenter ellipsoid. Due to energy attenuation during propagation, an elastic wave continuously decreases in terms of amplitude. Plural elastic-wave collecting components 9 arranged around the hypocenter 10 can collect amplitude data of elastic waves of different sized from the hypocenter 10 in multiple directions, thereby achieving detection of the spatial radiation displacement field.

The elastic-wave collecting components 9 send the amplitude data they collect to the processor 2 via communication components. The processor 2 processes the amplitude data so as to enable construction of the fundamental elliptic equation. Preferably, the processor 2 processes the amplitude data through steps detailed below.

As shown in Table 5, Table 6, and Table 7, when receiving the data collected by the elastic-wave collecting components 9, the processor, from the acoustic emission waveform data, extracts all events and the amplitude level received at each channel by means of short-time Fourier transform, and stores all the data of event time points, coordinates, and amplitude levels. Preferably, considering the attenuation of the elastic wave, attenuation compensation of the received waveform amplitude is performed according to the propagation distance and frequency, after which a displacement field on the radius of the sphere is obtained, which displacement field is an ellipsoid.

S1 is about constructing spatial propagation vectors of the hypocenter.

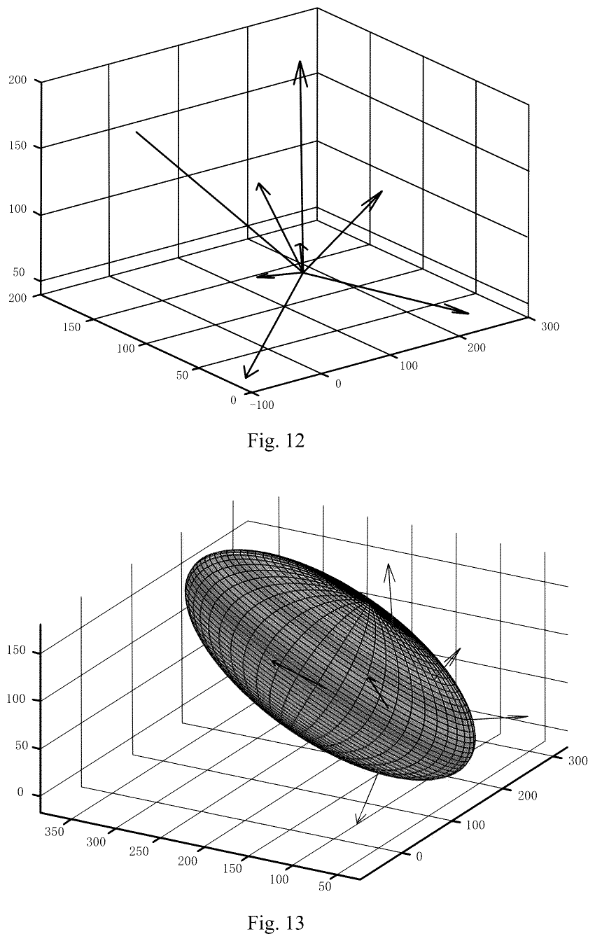

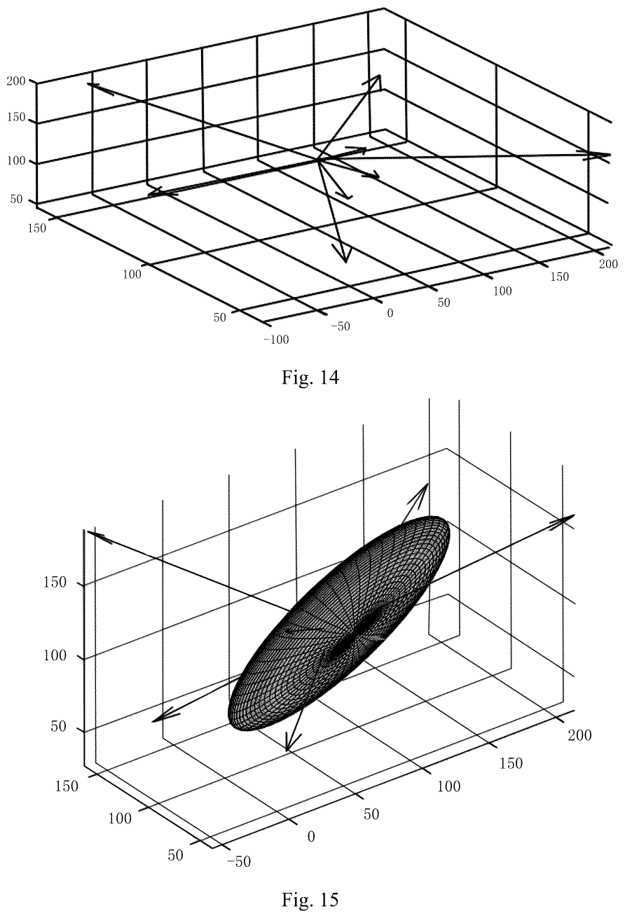

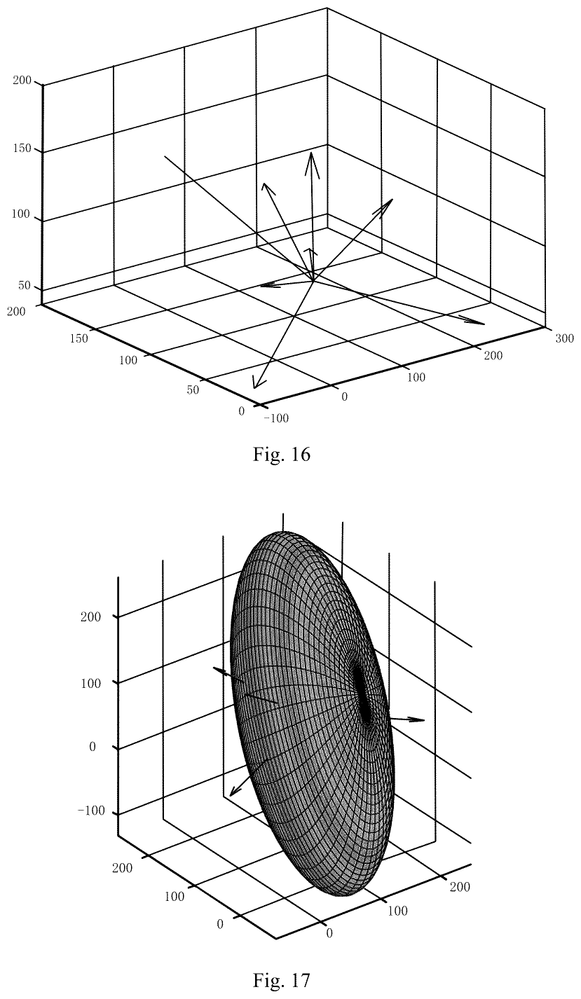

Referring to FIG. 11, FIG. 12, FIG. 13, FIG. 15, and FIG. 17, a spatial coordinate system is constructed. The origin is defined by the constructor, and the spatial coordinates x, y, z are used to represent the location of the hypocenter. As shown, the amplitude level is used to represent the displacement of the spatial radiation displacement field of the hypocenter 10. The data points representing the amplitude level are linked to the location point of the hypocenter 10, so as to obtain the spatial direction of energy propagation from the hypocenter, which is also referred to as the hypocenter-detecting vector direction. With consideration of wave attenuation in the direction of the hypocenter-detecting vectors, initial displacement from the hypocenter 10 in all directions can be obtained, i.e., the sizes of the hypocenter-detecting vectors. With 4 or more elastic-wave collecting components 9 receiving waveform data radiated from the hypocenter 10, the hypocenter 10 can be located by difference of times. In the present disclosure, if the data channels are few, and the average coverage ratio is small, the fitting quality of the hypocenter ellipsoid will be poor. When there are only 4 data channels, the average coverage ratio between the hypocenter ellipsoid and the hypocenter-detecting vectors will be relatively small.

FIG. 11 shows 6 hypocenter-detecting vectors 8 each in a different direction. Each of the hypocenter-detecting vectors has a size reflecting the initial displacement of the elastic wave in the corresponding direction.

At S2, a sphere covering the spatial radiation of the hypocenter is constructed.

As shown in FIG. 13, a reference sphere is set within the spatial distribution scope of the fissure vectors. For example, a sphere centered at the hypocenter with a predetermined radius is drawn. Preferably, the radius of the sphere may be set arbitrarily. Preferably, the radius of the sphere is greater than the wavelengths of the elastic waves. The waveforms of elastic waves collected by the elastic-wave collecting components 9 spatially located to be in different directions and at different distances are calibrated in terms of attenuation against this sphere as reference. The waveform amplitude in different directions on the sphere can thus be obtained. In the present disclosure, the hypocenter sphere of the acoustic monopole as described previously is essentially a sphere. The elastic-wave spatial radiation generated during formation of the fissures is a hypocenter ellipsoid. Using the amplitude of the elastic waves on the hypocenter sphere, its fundamental elliptic equation and standard equation can be obtained, thereby structurally characterizing the fissures.

At S3, the fundamental elliptic equation of the hypocenter ellipsoid of the present disclosure is obtained through calculation.

At S31, the fundamental elliptic equation is constructed.

The fundamental elliptic equation may be represented by:

$$F ( x , y , z ) = {a}_{11} {x}^{2} + {a}_{22} {y}^{2} + {a}_{33} {z}^{2} + 2 {a}_{12} xy + 2 {a}_{13} xz + 2 {a}_{23} yz + 2 {a}_{14} x + 2 {a}_{24} y + 2 {a}_{34} z + {a}_{44} \qquad ( 1 )$$

where x, y, z coordinates represent the amplitude coordinates on the hypocenter sphere. The values of x, y, and z are each calculated by multiplying the hypocenter-detecting vector by the cosine of its direction. a represents the coefficient, which is obtained through calculation from the amplitude data collected by the elastic-wave collecting components 9.

At S32, the fundamental elliptic equation is modified into the standard form.

Since the spatial geometric parameters of the hypocenter ellipsoid cannot be derived directly from the fundamental elliptic equation, it is necessary in the present disclosure to modify the fundamental elliptic equation (1) into the standard form. The spatial geometric parameters of the hypocenter ellipsoid include the center, the lengths of the axes, and the focus coordinates.

The standard form of the ellipsoid may be represented as:

$$F ( x , y , z ) = \frac{{( x - {x}_{0} )}^{2}}{{a}^{2}} + \frac{{( y - {y}_{0} )}^{2}}{{b}^{2}} + \frac{{( z - {z}_{0} )}^{2}}{{c}^{2}} - 1 \qquad ( 2 )$$

where x₀, y₀, z₀ represent the center coordinates of the hypocenter ellipsoid; and a, b, and c represent the lengths of the semi-major, semi-median, and semi-minor axes of the hypocenter ellipsoid, respectively. With the center of the hypocenter ellipsoid located, fissure expansion directions can be represented simply using the location of the hypocenter.

The coefficients of the fundamental elliptic equation can be simplified into the form below:

$$A = \{ \begin{matrix}{a}_{11} & {a}_{12} & {a}_{13} & {a}_{14} \\ {a}_{12} & {a}_{22} & {a}_{23} & {a}_{24} \\ {a}_{13} & {a}_{23} & {a}_{33} & {a}_{34} \\ {a}_{14} & {a}_{24} & {a}_{34} & {a}_{44}\end{matrix} \} , A *= \{ \begin{matrix}{a}_{11} & {a}_{12} & {a}_{13} \\ {a}_{12} & {a}_{22} & {a}_{23} \\ {a}_{13} & {a}_{23} & {a}_{33}\end{matrix} \} , \qquad ( 3 )$$

$${K}_{3} = \vert A \vert , {I}_{3} = \vert A * \vert$$

where I₃ represents the third invariant in Matrix A*, and K₃ represents the third semi-invariant of A, with values thereof being determinants corresponding to the matrix.

Moreover, the eigenvalues (λ₁, λ₂, λ₃) and the unit eigenvectors (η₁, η₂, η₃) corresponding to A* can be also obtained.

Based on the aforementioned parameters, the center X_{c}=(x_{c}, y_{c}, z_{c}), lengths of semi axes (a, b, c), and linear eccentricity (pseudo) of the ellipsoid can be obtained as:

$${{X}_{c}}^{T} = - {{( {A}^{*} )}^{-} [ \begin{matrix}{a}_{14} & {a}_{24} & {a}_{34}\end{matrix} ]}^{T} \qquad ( 4 )$$

$$a = \sqrt{\vert \frac{{K}_{3}}{{λ}_{1} {I}_{3}} \vert} , b = \sqrt{\vert \frac{{K}_{3}}{{λ}_{2} {I}_{3}} \vert} , c = \sqrt{\vert \frac{{K}_{3}}{{λ}_{3} {I}_{3}} \vert} \qquad ( 5 )$$

$${C}_{0} = \sqrt{{a}^{2} - {b}^{2}} \qquad ( 6 )$$

where X_{c}^{T} represents the center coordinates of the hypocenter ellipsoid (x₀, y₀, z₀); a, b, and c represent the lengths of the semi-axes of the hypocenter ellipsoid in three-dimensional directions, respectively; and C₀ represents the linear eccentricity of the principal plane of the hypocenter ellipsoid. The direction corresponding to the first axis (or the major axis) of the hypocenter ellipsoid is determined by the eigenvector η₁. The focus of the ellipsoid is on the major axis, and its coordinates can be calculated from the coordinates of the center of sphere. As such, all the spatial geometric parameters of the hypocenter ellipsoid have been obtained.

In the present disclosure, the spatial geometric parameters of the hypocenter ellipsoid can be determined through simple calculation and the geometrical form is intuitive.

Currently, in the field of seismology, determination of spatial geometric parameters of a hypocenter is mainly achieved by performing moment tensor inversion on seismic waveforms collected by multiple seismic stations (6 or more), so as to identify the magnitude and the type of the hypocenter. Then on the basis of some theoretical assumptions, complicated methods of dynamics are used to calculate the spatial geometric characteristics of the hypocenter. The calculation process is complex and since the geometrical parameters of a hypocenter are separated from the physical process, the interpretation requires sophisticated professional discipline. Petra Adamovi et al. uses a higher-order Green function to perform hypocenter ellipsoid fitting. While they indicate that the axes of a hypocenter ellipsoid represent the expansion directions of the hypocenter, their method fails to combine other geometric characteristics of the ellipsoid with physical characteristics of the hypocenter. Besides, the known method requires higher-order inversion fitting for moment tensors, which involves complicated computing. According to the known method, the shape and spatial orientations of the obtained ellipsoid may have change when different frequency components are used for fitting, so the result lacks for uniqueness.

Secondly, the present disclosure uses the spatial radiation amplitude (the greatest amplitude) of the hypocenter as the original data for fitting. The greatest amplitude is obtained by performing Fast Fourier Transform on waveforms collected by the elastic-wave collecting components 9. At least 4 sets of waveform data from the elastic-wave collecting components 9 are required. By using the least squares method to perform fitting on the greatest amplitude for the hypocenter ellipsoid, the spatial geometric parameters of the hypocenter ellipsoid can be determined uniquely. The volume of the hypocenter ellipsoid can represent the energy level of the hypocenter. The spatial distribution of the hypocenter ellipsoid can represent the spatial damage scope of the hypocenter. The first principal plane of the hypocenter ellipsoid can represent the spatial distribution of the fault. The ratio between the first axis and the third axis of the hypocenter ellipsoid can represent the type of the hypocenter. The direction from the location of the hypocenter to the center of the hypocenter ellipsoid represents fissure expansion directions. To sum up, the present disclosure can obtain physical parameters of the hypocenter from the spatial geometric parameters of the hypocenter ellipsoid. The calculation is simple and the physical process is clear and intuitive. Even people without professional background can easily understand.

With the hypocenter 10 being the focus on the major axis of the hypocenter ellipsoid, the parameters of the hypocenter ellipsoid are right the parameters of the hypocenter fissures. In other words, the fracturing process can be quantitatively described using the amplitude parameters of the hypocenter 10. For example, Table 5 shows the amplitude data from 6 channels.

TABLE 5
Samples of 6-Channel Amplitude Data

| Time | X | Y | Z | Channel 1 | Channel 2 | Channel 3 | Channel 4 | Channel 5 | Channel 6 |
|---|---|---|---|---|---|---|---|---|---|
| 0.136219 | 30.27 | 11.03 | 16.53 | 28.23557 | 12.18803 | 27.41902 | 9.640345 | 25.6591 | 20.44379 |
| 0.152941 | 33.41 | 13.06 | 21.76 | 0 | 15.20131 | 28.11388 | 11.99637 | 23.3403 | 21.41633 |
| 0.214623 | 30.61 | 15.17 | 14.15 | 0 | 12.68305 | 33.33499 | 4.274513 | 0 | 23.61412 |
| 0.225348 | 13.9 | 9.96 | 21.46 | 0 | 11.66029 | 26.32858 | 11.67416 | 18.08814 | 21.8923 |
| 0.356321 | 13.85 | 8.89 | 10.53 | 28.38473 | 10.6199 | 28.25424 | 11.6073 | 21.02707 | 23.42515 |
| 0.429469 | 19.44 | 8.177 | 26.93 | 26.19241 | 13.83661 | 26.81439 | 14.83659 | 20.67242 | 22.8301 |
| 0.481576 | 30.6 | 11.52 | 38.74 | 23.3302 | 0 | 23.38311 | 0 | 20.29045 | 15.79462 |
| 0.504688 | 20.97 | 17.3 | 34.85 | 24.48194 | 0 | 23.91414 | 0 | 17.88894 | 20.61371 |
| 0.615862 | 36.57 | 9.293 | 10.59 | 32.87719 | 11.88582 | 29.58042 | 12.30084 | 26.47351 | 20.93248 |
| 0.618325 | 26.92 | 13.73 | 5.901 | 0 | 12.42388 | 30.18817 | 8.187482 | 24.89924 | 26.27332 |
| 0.6401 | 26.82 | 2.576 | 40.24 | 24.98759 | 0 | 26.73289 | 0 | 19.22764 | 17.52275 |
| 0.649091 | 27.16 | 15.14 | 26.01 | 26.79594 | 19.84652 | 27.78124 | 14.39835 | 21.51994 | 19.52869 |
| 0.692735 | 37.44 | 12.17 | 26.05 | 30.96217 | 19.07138 | 28.63136 | 15.82756 | 24.82421 | 20.51888 |
| 0.748959 | 22.61 | 10.26 | 75.02 | 10.30296 | 0 | 10.65378 | 0 | 18.60794 | 19.40902 |
| 0.774445 | 36.35 | 6.909 | 18.78 | 32.30792 | 14.52684 | 27.1394 | 14.66564 | 24.1686 | 21.28007 |
| 0.78533 | 36.59 | 9.373 | 51.2 | 20.34372 | 0 | 20.94171 | 27.55525 | 23.13706 | 10.1109 |
| 0.824574 | 25.68 | 6.06 | 42.74 | 25.10813 | 0 | 26.31748 | 0 | 21.03196 | 18.26244 |
| 0.870212 | 20.43 | 8.351 | 25.71 | 26.10978 | 12.44539 | 29.44929 | 14.7243 | 19.71543 | 21.29782 |
| 0.919464 | 35.77 | 13.14 | 24.38 | 0 | 14.46851 | 0 | 12.07836 | 23.08204 | 18.90145 |
| 1.270494 | 22.65 | 10.61 | 23.35 | 0 | 12.17464 | 30.82735 | 10.20826 | 0 | 20.32726 |

In Table 5, the first column shows the times the event happened. Columns X, Y, and Z represent coordinates of the hypocenters 10. Channels 1˜6 list the amplitude of data of the channels, respectively. The hypocenter-detecting vectors 8 can be constructed from the data of Table 5, as shown in FIG. 11. In FIG. 11, there are 6 hypocenter-detecting vectors 8 each in a different direction. The 6 hypocenter-detecting vectors 8 all set out from the hypocenter 10.

In Table 6, Columns 1-3 show the center coordinates of the hypocenter ellipsoids; Columns 4-6 list lengths of the semi-major, semi-median, and semi-minor axes; Columns 7-9 are the unit vectors of the first axis, the second axis, and the third axis, respectively; and Column 10 provides the average coverage ratios. The processor 2 uses the data sample of Table 6 to construct the hypocenter ellipsoid. The processor 2 calculates the spatial geometric parameters of the hypocenter ellipsoid based on the standard form of the ellipsoid, as shown in Table 6.

TABLE 6
Spatial Geometric Parameters of Fit Hypocenter Ellipsoid

| | | | | | | | | | | Coverage |
|---|---|---|---|---|---|---|---|---|---|---|
| x | y | z | a | b | c | Nmd1 | Nmd2 | Nmd3 | ratioEL | Ratio |
| 21.97213 | 6.205841 | 30.92322 | 24.30762 | 17.07537 | 12.14964 | −0.47964 | −0.27885 | 0.831975 | 3.078696 | 97.51% |
| 2.299396 | 53.45679 | 49.41945 | 61.26185 | 19.70275 | 12.68285 | −0.53632 | 0.696412 | 0.476829 | 13.1662 | 86.84% |
| 31.70472 | 11.97617 | 34.42581 | 21.33611 | 5.720332 | 4.977476 | −0.59585 | −0.79763 | −0.09347 | 23.54916 | 68.14% |
| 20.18127 | 7.244621 | 36.12523 | 22.70018 | 15.91859 | 11.2595 | 0.388135 | −0.16779 | 0.9062 | 5.288856 | 94.10% |
| 5.355304 | 4.004747 | 5.542755 | 23.52326 | 20.79532 | 10.83653 | −0.77257 | −0.4443 | −0.45358 | 4.99347 | 95.95% |
| 22.5636 | 8.837742 | 37.67106 | 21.49271 | 18.34046 | 14.59974 | 0.278755 | 0.058966 | 0.95855 | 5.634601 | 95.50% |
| −55.6591 | 91.62675 | 493.829 | 473.2664 | 54.9305 | 24.55744 | −0.1835 | 0.170415 | 0.968135 | 10.33938 | 87.51% |
| 30.2047 | −28.8712 | 21.10026 | 52.65808 | 19.15091 | 15.61968 | 0.188263 | −0.94127 | −0.28031 | 6.20294 | 92.86% |
| 53.97552 | 22.07973 | −2.89957 | 29.87635 | 15.62612 | 6.087382 | 0.683531 | 0.502147 | −0.52975 | 7.952849 | 94.07% |
| 18.02448 | 13.15792 | 58.92668 | 54.1892 | 6.729757 | 5.33562 | 0.70897 | 0.693815 | 0.126421 | 15.76693 | 84.54% |
| 201.8462 | 120.6902 | 253.3836 | 302.4656 | 38.34226 | 24.73746 | 0.583371 | 0.39368 | 0.710418 | 8.974359 | 89.86% |
| 42.41732 | 36.59303 | 18.14779 | 34.68095 | 21.1645 | 13.74934 | 0.555332 | 0.780842 | −0.28617 | 6.798833 | 94.76% |
| 53.75432 | 41.19409 | 16.15819 | 44.01992 | 27.0435 | 18.43036 | 0.469702 | 0.835627 | −0.28479 | 10.00568 | 92.84% |
| 27.28841 | 18.03884 | 141.8027 | 69.08416 | 15.17531 | 7.290669 | 0.069416 | 0.115419 | 0.990888 | 18.24316 | 69.07% |
| 39.27016 | 18.43924 | 21.96889 | 26.14454 | 23.06282 | 14.98038 | 0.237135 | 0.936327 | 0.258957 | 10.07127 | 92.49% |
| 39.99043 | 13.92258 | 70.1727 | 22.12974 | 9.874237 | 5.447448 | −0.3862 | 0.91029 | −0.14907 | 17.04778 | 83.30% |
| 29.88087 | 43.2467 | 24.67767 | 48.99426 | 25.95556 | 19.33258 | 0.101094 | 0.894898 | −0.43467 | 14.71535 | 83.78% |
| 23.20657 | 3.876426 | 39.3071 | 22.8623 | 17.60887 | 16.19622 | 0.190421 | −0.30687 | 0.932507 | 3.729271 | 96.99% |
| 39.5298 | 17.76418 | 30.10311 | 9.505012 | 4.698097 | 4.431034 | −0.26155 | −0.65953 | 0.70471 | 13.19238 | 80.75% |
| 27.47536 | 1.899496 | 43.61126 | 27.6506 | 15.96496 | 9.888022 | 0.213738 | −0.38583 | 0.897469 | 9.05315 | 87.69% |
| 24.9539 | 3.483513 | 9.92373 | 19.84516 | 16.25061 | 3.140856 | 0.892248 | 0.423645 | 0.156262 | 5.912305 | 92.28% |
| 27.2287 | 5.175372 | 26.04481 | 25.4687 | 16.45581 | 10.36255 | −0.3859 | −0.05076 | 0.921145 | 5.865179 | 95.68% |
| 2.786471 | 5.25076 | 7.103796 | 21.69609 | 21.32267 | 13.86581 | −0.36565 | −0.0814 | −0.92719 | 3.967242 | 97.11% |
| 6.89796 | −8.86432 | 25.39296 | 37.32065 | 18.88976 | 6.353691 | −0.57576 | −0.62181 | 0.530895 | 7.709201 | 88.89% |
| 16.09104 | 14.51189 | 12.90154 | 17.68409 | 5.180949 | 2.205862 | 0.522433 | −0.83721 | 0.16167 | 7.329511 | 93.46% |
| 25.43558 | 15.7761 | 14.20071 | 13.01057 | 1.941752 | 1.870667 | −0.71422 | 0.699838 | −0.01054 | 37.94833 | 65.35% |
| 28.49072 | 5.267182 | 39.61699 | 17.24907 | 10.58832 | 4.634106 | 0.603039 | 0.750708 | 0.26978 | 25.18005 | 63.98% |
| 25.71302 | 23.1467 | 11.90739 | 14.37106 | 12.19782 | 5.660514 | −0.00092 | 0.554922 | 0.831902 | 4.894085 | 95.77% |

As shown in FIG. 11, when the number of the data channels is below 4, the quantity of collected data too insufficient to form an ellipsoid through fitting. When the number of data channels is greater than or equal to 4, the quantity of data collected is enough to form an ellipsoid through fitting but the fitting quality may be inconsistent. In the present disclosure, the fitting quality of the hypocenter ellipsoid is assessed with reference to the coverage ratios of the hypocenter ellipsoid with respect to the hypocenter-detecting vectors. As demonstrated by a large amount of experimental data, with data collected through 6 or more channels, the coverage ratio of the hypocenter ellipsoid can be greater than 90%, meaning that the fitting quality is satisfying. When the number of channels is smaller than 6, the coverage ratio of the hypocenter ellipsoid is smaller than 80%, indicating poor fitting quality.

Preferably, the processor 2 uses the least squares method to calculate the spatial geometric parameters of the hypocenter ellipsoid.

In a case interpolation is not required, the spatial geometric parameters of the hypocenter ellipsoid may be obtained through the equation below.

$$min G ( A ) = \frac{4 π ( ab + bc + ac )}{3} \qquad ( 7 - 1 )$$

where min G (A) represents the objective function; a represents the length of the semi-major axis; b represents the length of the semi-median axis; and c represents the length of the semi-minor axis.

When the objective function is set as the ellipsoid volume,

$$min {G}^{′} ( A ) = \frac{4 π abc}{3} \qquad ( 7 - 2 )$$

where min G′ (A) represents the ellipsoid volume.

The above equation after simplified is equivalent to:

$$min {G}^{″} ( A ) = - \vert {I}_{3} \vert \qquad ( 7 - 3 )$$

where min G″ (A) represents the ellipsoid volume, I₃=|A*|.

The first constraint is the n linear equations, or n fundamental elliptic equations, constructed using the channel hypocenter radiation vectors. At this time the variable is the element of Matrix A, and x, y, and z represent the spatial radiation coordinates collected by the elastic-wave collecting components 9 on the hypocenter sphere, so:

$${a}_{11} {x}^{2} + {a}_{22} {y}^{2} + {a}_{33} {z}^{2} + {a}_{12} xy + {a}_{13} xz + {a}_{23} yz + {a}_{14} x + {a}_{24} y + {a}_{34} z + {a}_{44} = 0 \qquad ( 8 )$$

The second constraint is the coefficient condition of the ellipsoid equation in the standard form, which is:

$$\frac{{K}_{3}}{{λ}_{1} {I}_{3}} > \frac{{K}_{3}}{{λ}_{2} {I}_{3}} > \frac{{K}_{3}}{{λ}_{3} {I}_{3}} > 0 \qquad ( 9 )$$

The third constraint is the condition of the solution of the characteristic equation of the quadratic term coefficient matrix of the ellipsoid equation, namely the condition that a one variable cubic equation has three real roots, so:

$$Δ = 4 {{I}_{1}}^{3} {I}_{3} - {{I}_{1}}^{2} {{I}_{2}}^{2} - 18 {I}_{1} {I}_{2} {I}_{3} + 27 {{I}_{3}}^{2} \leq 0 \qquad ( 10 )$$

where I₁ represents the first invariant of Matrix A*; I₂ represents the second invariant of Matrix A*; and I₃ represents the third invariant of Matrix A*.

The fourth constraint is the condition of the focus. The source coordinates (x_{c}, y_{c}, z_{c}) are identical to the focus coordinates obtained from the lengths of the semi-axes and the linear eccentricity through calculation, which is expressed as:

$${x}_{c} = {x}_{0} - {C}_{0} {η}_{1} ( 1 ) , {y}_{c} = {y}_{0} - {C}_{0} {η}_{1} ( 2 ) , {z}_{c} = {z}_{0} - {C}_{0} {η}_{1} ( 3 ) \qquad ( 11 )$$

where x₀, y₀, z₀ represent the venter coordinates of the hypocenter ellipsoid; C₀ represents the linear eccentricity; and ηₗ represents the unit principal vector in the principal axis direction. In this equation, (1), (2), and (3) represent that there are 3 direction vectors, and each direction vector is represented by 3 components.

The radiation energy of the hypocenter ellipsoid is strongest in the major axis direction of radiation, marked as the fissure expansion direction. The distance from determined focus of the first and second axes of the hypocenter ellipsoid to the center of the hypocenter ellipsoid, namely the pseudo focal length, is the length of fissure expansion (or slip). According to the expansion direction and expansion length of a fissure, the orientation of the fissure can be determined. The type of the hypocenter can be determined according to the ratio between the first axis and the third axis of the hypocenter ellipsoid. When the median axis/major axis percentage of the hypocenter ellipsoid is greater than 50%, the fissure is of the shear type; otherwise, it is of the tension type fissure, as shown in Table 7.

TABLE 7
Determination of Hypocenter Type

| Type of Fissure | Minor Axis b/Major Axis a |
|---|---|
| Shear-Type | 90.10% |
| | 60.01% |
| Tension-Type | 42.63% |
| | 45.89% |

Table 8 shows Sample 1 of 2 sets of 8-channel amplitude data according to the present disclosure. The hypocenter-detecting vector and the hypocenter ellipsoid corresponding thereto are FIG. 12 and FIG. 13 as well as FIG. 14 and FIG. 15, respectively.

TABLE 8
Sample 1 of 8-Channel Amplitude Data

| Time | x | y | z | Channel 1 | Channel 2 | Channel 3 | Channel 4 | Channel 5 | Channel 6 | Channel 7 | Channel 8 | a | b | c |
|---|---|---|---|---|---|---|---|---|---|---|---|---|---|---|
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |

[symbol]

indicates data missing or illegible when filed

As shown in Table 8, the hypocenter ellipsoid of FIG. 13 has a median axis/major axis percentage of 90.10%, and the hypocenter ellipsoid of FIG. 15 has a median axis/major axis percentage of 60.01%, so the both are shear-type fissures.

TABLE 9
Sample 2 of 8-Channel Amplitude Data

| Tension- | | | | | | | | | | | | | | |
|---|---|---|---|---|---|---|---|---|---|---|---|---|---|---|
| type | | | | | | | | | | | | | | |
| Time | x | y | z | Channel 1 | Channel 2 | Channel 3 | Channel 4 | Channel 5 | Channel 6 | Channel 7 | Channel 8 | a | b | c |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |

[symbol]

indicates data missing or illegible when filed

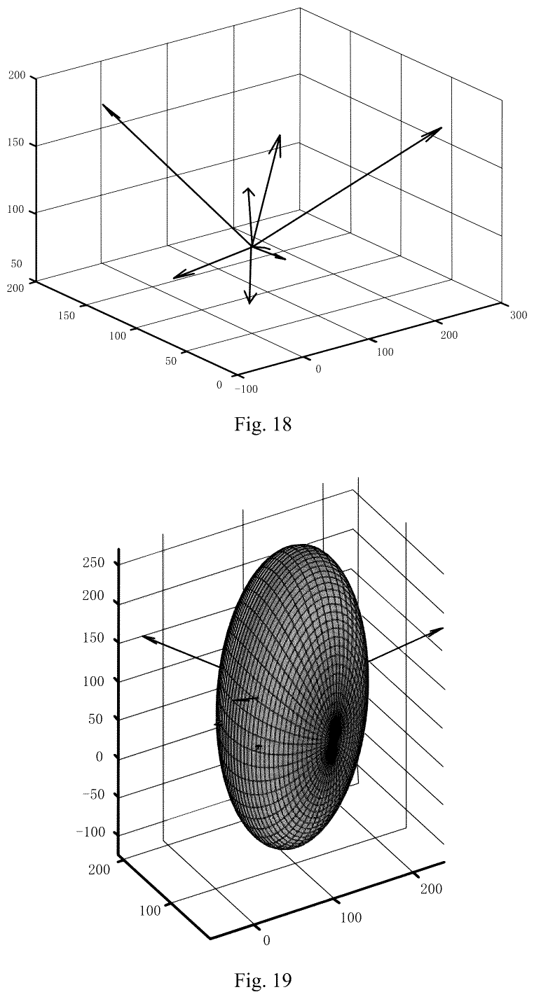

Table 9 shows Sample 2 of 2 sets of 8-channel amplitude data according to the present disclosure. The hypocenter-detecting vector and the hypocenter ellipsoid corresponding thereto are FIG. 16 and FIG. 17 as well as FIG. 18 and FIG. 19, respectively.

As shown in Table 9, the hypocenter ellipsoid of FIG. 17 has a median axis/major axis percentage of 42.63%, and the hypocenter ellipsoid of FIG. 19 has a median axis/major axis percentage of 45.89%, so the both are tension-type fissures.

Preferably, when the number of data channels is greater than or equal to 10, the processor does not need to perform random interpolation in the principal plane of the hypocenter ellipsoid. When the number of data channels is smaller than 10, the processor has to perform random interpolation in the principal plane of the hypocenter ellipsoid.

Preferably, where interpolation is requested, the present disclosure performs random interpolation for the hypocenter ellipsoid through the following steps.

S51 involves determining the principal plane.

As shown in FIG. 20, the direction of the greatest amplitude is taken as the first principal direction of the hypocenter ellipsoid, and the greatest amplitude is taken as the maximum radiation of the major axis, i.e., \vec{B}ₘₐₓ. Then the cross product of each of the other hypocenter-detecting vector and the greatest hypocenter-detecting vector is calculated, and the maximum of the mode of \vec{C}ᵢ is the hypocenter-detecting vector \vec{B}ₘₐₓ corresponding to max∥\vec{C}ᵢ∥. The unit vector obtained by calculating the cross product of the hypocenter-detecting vector \vec{B}ₘₐₓ and hypocenter-detecting vector is the normal direction of the principal plane, i.e.,

$${\vec{N}}_{1} = \frac{{\vec{C}}_{max}}{‖ {\vec{C}}_{max} ‖} .$$

Then the other hypocenter-detecting vectors are represented. \vec{C}ₘₐₓ represents the hypocenter-detecting vector \vec{C}ᵢ having the greatest mode, and ∥\vec{C}ₘₐₓ∥ represents the mode of \vec{C}ₘₐₓ. The direction perpendicular to the first axis in the principal plane is the second axis direction. The size of the projection of the hypocenter-detecting vector \vec{B}ₘₐₓ on the second axis is the size of the second axis, i.e.,

$${\vec{B}}_{⊥} = \frac{max ‖ {\vec{C}}_{i} ‖}{‖ {\vec{B}}_{max} ‖} .$$

Therein, \vec{B}_{⊥} represents the size of the second axis.

S52 is about making points randomly.

As shown in FIG. 21, 2 points are made randomly within a range of 5 degrees apart from the first principal direction at one side and sized 0.9˜1.1\vec{B}ₘₐₓ. Then, 2 points are made randomly within a range of 15 degrees apart from the first principal direction at the other side and sized 0.9˜1.1\vec{B}ₘₐₓ. At last, 2 points are made randomly along the second principal direction and sized 0.9˜1.1\vec{B}_{⊥}.

Except for the two hypocenter-detecting vectors of the principal plane, for all the hypocenter-detecting vectors, points are made in a mirroring manner. Each hypocenter-detecting vector and the normal direction of the principal plane define an included angle sized α. When the included angle α is smaller than π/2, the point is made in the direction that works with the hypocenter-detecting vector to define an included angle of π−2α, and the point is sized 0.9˜1.1\vec{B}ᵢ. When the included angle is greater than π/2, the point is made in the direction that works with the hypocenter-detecting vector to define an included angle of 2α−π, and the point is sized 0.9˜1.1\vec{B}ᵢ.

At S53, the fitting quality is assessed.

The fitting quality is determined better when the area of the hypocenter ellipsoid is smaller and covers more hypocenter-detecting vectors.

Specifically, the hypocenter ellipsoid formed through fitting is coupled with each hypocenter-detecting vector equation and the intersection between the two is found. The root of the sum of squares of residuals between individual hypocenter-detecting vectors and the intersection is extracted and then divided by the number of the amplitude channels so as to obtain the average coverage difference with respect to the hypocenter-detecting vectors. The average coverage difference is then divided by the sum of the amplitudes and multiplied by the percentage to produce the value of the coverage difference ratio. At last, by subtracting the value from 1, the coverage ratio of the hypocenter ellipsoid can be determined. The greater the coverage ratio of the hypocenter ellipsoid is, the better the fitting quality is.

By randomly adding points in the principal plane as described previously, the present disclosure makes most average coverage differences below 10 mm. The principal plane of the hypocenter ellipsoid can represent the spatial distribution direction of the fault.

For example, the hypocenter ellipsoid may be expressed as:

$$F ( x , y , z ) = {a}_{11} {x}^{2} + {a}_{22} {y}^{2} + {a}_{33} {z}^{2} + {a}_{12} xy + {a}_{13} xz + {a}_{23} yz + {a}_{14} x + {a}_{24} y + {a}_{34} z + {a}_{44} = 0.$$

Assuming that the location of the hypocenter in the space is M₀(x₀, y₀, z₀) and the hypocenter-detecting vector \vec{B}ᵢ=(m, n, p), the vertex coordinates of the hypocenter-detecting vector are (x₂, y₂, z₂), with M(x, y, z) being an arbitrary point in the hypocenter-detecting vector, the hypocenter-detecting vector equation is

$$\frac{x - {x}_{0}}{m} = \frac{y - {y}_{0}}{n} = \frac{z - {z}_{0}}{p} .$$

The fundamental elliptic equation is coupled with the hypocenter-detecting vector equation and the intersection M1(x₁, y₁, z₁) of the two is figured out. The residual (distance) between the hypocenter-detecting vector and the intersection is dᵢ=\sqrt{(x₂−x₁)²+(y₂−y₁)²+(z₂−z₁)²}. The average coverage difference of the hypocenter-detecting vectors is

$$D = \frac{\sqrt{{\sum }_{i = 1}^{n} {d}_{i}^{2}}}{n} ;$$

the sum of the amplitudes is A=Σᵢ₌₁ⁿAᵢ; and the coverage ratio of the hypocenter ellipsoid is

$$( 1 - \frac{D}{A} ) * 100 \% .$$

TABLE 10
Calculation of Coverage Ratio of Hypocenter Ellipsoid with 6-Channel Data

| Vertex Coordinates of | | Intersection M₁ between | Residual |
|---|---|---|---|
| Hypocenter-Detecting | Amplitude | Hypocenter-Detecting | (Distance) |
| Vector | Size | Vector and Ellipsoid | Dᵢ |
| (21.87, 13.34, 52.49) | 27.04 | (20.24, 11.71, 50.85) | 8.01 |
| (23.71, 17.25, 17.39) | 16.97 | (19.66, 8.64, 26.45) | 13.13 |
| (21.95, 4.49, 53.37) | 28.48 | (20.18, 7.08, 34.78) | 18.86 |
| (24.63, 0.54, 15.320) | 21.44 | (25.41, −0.60, 13.58) | 2.22 |
| (6.14, 9.42, 42.71) | 18.15 | (18.10, 8.30, 28.53) | 18.58 |
| (37.64, 9.26, 40.67) | 21.61 | (27.57, 8.66, 33.07) | 12.63 |
| | Average | | Coverage Ratio of |
| Sum of Squares of | Coverage | | Hypocenter |
| Residual | Difference | Sum of Amplitude | Ellipsoid |
| 8.01² +13.13² + 18.86² + 2.22² + 18.58² +12.63² = 1102.12 | $\frac{\sqrt{1102.12}}{6} = 5.533$ | 27.04 + 16.97 + 28.48 + 21.44 + 18.15 + 21.61 = 115.54 | $( 1 - \frac{5.533}{115.54} ) * 100 \% = 95.21 \%$ |

Table 10 shows calculation of the related parameters and average coverage difference of hypocenter ellipsoid based on fitting for hypocenter data with 6 data channels. The average coverage difference is 5.533, and the hypocenter ellipsoid coverage ratio is 95.21%, meaning that the fitting quality of the hypocenter ellipsoid is satisfying.

At S6, based on the fit hypocenter ellipsoid, the hypocenter can be quantitatively characterized.

The hypocenter is quantitatively described as a hypocenter ellipsoid based on its spatial energy radiation characteristics. This is applicable to description of hypocenters in all scales inside solid objects having physical processes such as generation, connection, slip, and/or activation of fissures and/or faults.

The radiation energy of the hypocenter ellipsoid is strongest in the major axis direction of radiation, marked as the fissure expansion direction. The distance from determined focus of the first and second axes of the hypocenter ellipsoid to the center of the hypocenter ellipsoid, namely the pseudo focal length, is the length of fissure expansion (or slip). According to the Doppler effect, the fissure expansion rate can be calculated from the hypocenter radiation, thereby achieving focal mechanism solution.

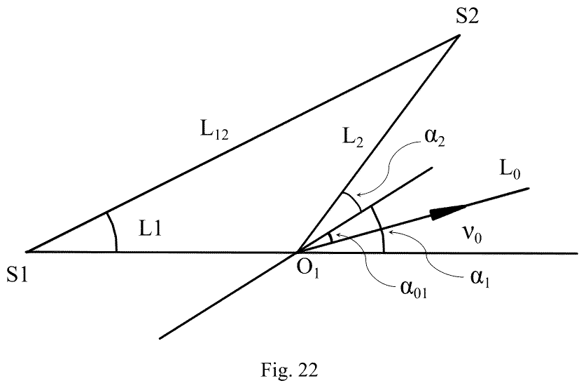

As shown in FIG. 22, according to the Doppler effect, the equation for calculating the hypocenter rupture velocity:

$${u}_{0} = \frac{{v}_{0} Δ {f}_{12}}{( {f}_{1} cos {α}_{1} - {f}_{2} cos {α}_{2} ) cos {α}_{01}}$$

In the above equation, f₁ represents the hypocenter predominant frequency acquired by the first elastic-wave collecting component 9; f₂ represents the hypocenter predominant frequency acquired by the second elastic-wave collecting component 9, and v₀ represents the wave velocity in the medium. Therein, cos α₁ represents the projection of Angle α₁ in the direction of the link between the location S1 of the first elastic-wave collecting component and the location O₁ of the hypocenter. cos α₂ represents the projection of Angle α₂ in the direction of the link between the location S1 of the first elastic-wave collecting component and the location O₁ of the hypocenter. cos α₀₁ represents the projection of Angle α₀₁ in the direction of the link between the location S1 of the first elastic-wave collecting component and the location O₁ of the hypocenter. Δf₁₂ represents the difference between f₁ and f₂. Calculation thereof has been explained in Table 6.

In FIG. 22, S₁ and S₂ represent the locations of the elastic-wave collecting components; O₁ is the location of the hypocenter; and L₀ is the rupture direction determined by the axes of the hypocenter ellipsoid. Table 11 also shows examples of data of some rupture velocity parameters of the hypocenter and related parameters thereof.

TABLE 11
Calculation of Hypocenter Rupture Velocity

| f₁ | f₂ | v₀(km/s) | cosα₁ | cosα₂ | cosα₀₁ | Δf₁₂ | u₀(km/s) |
|---|---|---|---|---|---|---|---|
| 207.0313 | 203.125 | 1.933 | −0.17443 | 0.730726 | −0.80061 | 3.90625 | 0.051107 |
| 199.2188 | 191.4063 | 1.933 | 0.433644 | 0.897576 | −0.62257 | 7.8125 | 0.283998 |
| 93.75 | 91.79688 | 1.996 | 0.843238 | −0.69158 | 0.329559 | 1.953125 | 0.08299 |
| 41.01563 | 37.10938 | 1.996 | 0.878509 | −0.83372 | 0.851071 | 3.90625 | 0.136793 |
| 99.60938 | 93.75 | 1.996 | −0.74028 | 0.123238 | −0.62565 | 5.859375 | 0.219167 |

Table 11 shows five sets of example data for calculation of the hypocenter rupture velocity. In the five sets of data, the hypocenter rupture velocity increases gradually.

The present disclosure can be further used in the following scenarios.

A hypocenter mechanism can be built up simply using the hypocenter ellipsoid itself without the need of moment tensor inversion. The moment tensor is used in the forward calculation of the hypocenter ellipsoid radiation and is not essential.

The three axes of the hypocenter ellipsoid can represent stress triaxiality, stress status and/or stress orientation. Through fitting of the relation between energy and stress, the relation with stress can be built on the three axes, so as to determine a stress tensor, which is not available in all of existing measurement for crustal stress. One basic application of such a method is to estimate the stress status in the hypocenter region according to a foreshock. The orientation of stress can be directly determined using the hypocenter ellipsoid, and the size and direction of the principal stress can be determined using the size and orientation of the hypocenter ellipsoid.

Based on the hypocenter ellipsoid model of the present disclosure, a statistical law model for dynamic evolution of kinetic geological disasters can be established.

At S11, spatial geometric parameters in the hypocenter ellipsoid model are collected.

Preferably, the spatial geometric parameters related to failure characteristics are collected, such as the major axis parameters, so as to establish reliable damage variables, thereby making damage parameters consistent.

S12 is about describing the hypocenter.

The length of the major axis of the hypocenter ellipsoid throughout different stages meets the Poisson distribution, but the average value of the major axis of the hypocenter ellipsoid as a whole shall increase continuously until the characteristic length is reached. When the number of damages of the characteristic length reaches a certain threshold, the whole region monitored (rock samples, landslides, seismic blocks, etc.) can have failure. When there are defects, damages comparable to the characteristic length in terms of magnitude can happen early. These damages are associated to the final failure.

The present disclosure provides dynamic representation of a hypocenter 10. For example, with dynamic representation of an earthquake epicenter, the magnitude of the earthquake can be determined more accurately. As compared with the existing methods for determining magnitude of an earthquake epicenter, the method of the present disclosure can describe fissures at an earthquake epicenter more accurately and achieve more precise determination of magnitude.

It is to be noted that the particular embodiments described previously are exemplary. People skilled in the art, with inspiration from the disclosure of the present disclosure, would be able to devise various solutions, and all these solutions shall be regarded as a part of the disclosure and protected by the present disclosure. Further, people skilled in the art would appreciate that the descriptions and accompanying drawings provided herein are illustrative and form no limitation to any of the appended claims. The scope of the present disclosure is defined by the appended claims and equivalents thereof. The disclosure provided herein contains various inventive concepts, such of those described in sections led by terms or phrases like “preferably”, “according to one preferred mode” or “optionally”. Each of the inventive concepts represents an independent conception and the applicant reserves the right to file one or more divisional applications therefor.

What is claimed is:

1. A method for quantitative description of a fault/fissure, the method at least comprising:
collecting spatial coordinate data of the fault/fissure;
according to the spatial coordinate data, constructing a fundamental elliptic equation that covers a spatial distribution scope of the fault/fissure; and
characterizing the fault/fissure according to spatial geometric parameters of the fissure ellipsoid which is formed through fitting by using the fundamental elliptic equation.

2. The method of claim 1, wherein the step of, according to the spatial coordinate data, constructing a fundamental elliptic equation that covers a spatial distribution scope of the fault/fissure comprises:
according to the spatial coordinate data, constructing a polyhedron that covers the spatial distribution scope of the fault/fissure;
based on a geometric structure of the polyhedron, determining a center of gravity of the polyhedron;
according to the center of gravity and fissure vectors that are each formed by linking the center of gravity and a point of the spatial coordinate data, constructing the fundamental elliptic equation that covers the spatial distribution scope; and
based on the fundamental elliptic equation, forming the three-dimensional fissure ellipsoid.

3. The method of claim 2, wherein the step of, according to the spatial coordinate data, constructing a fundamental elliptic equation that covers a spatial distribution scope of the fault/fissure further comprises:
according to quantity of the spatial coordinate data, determining a way by which a coefficient of the fundamental elliptic equation is fit; and
according to the coefficient of the fundamental elliptic equation, determining the spatial geometric parameters of the fissure ellipsoid.

4. The method of claim 3, wherein the step of, according to quantity of the spatial coordinate data, determining a way by which a coefficient of the fundamental elliptic equation is fit at least comprises:
where the quantity of the received spatial coordinate data is not smaller than a predetermined data threshold, directly determining the coefficient of the fundamental elliptic equation through fitting; and
where the quantity of the received spatial coordinate data is smaller than the predetermined data threshold, fitting the coefficient of the fundamental elliptic equation by means of performing random interpolation in a principal plane of the fissure ellipsoid.

5. The method of claim 4, further comprising:
based on a third axis parameter of the fissure ellipsoid, describing geometric characteristics of a solid structural defect related to a width; and
based on an area and/or a normal direction of the principal plane of the fissure ellipsoid, describing spatial characteristics of the fissure.

6. The method of claim 5, further comprising:
based on an average coverage ratio of the fissure ellipsoid with respect to the fissure vectors, assessing ellipsoid fitting quality.

7. The method of claim 6, wherein the step of fitting the coefficient of the fundamental elliptic equation by performing random interpolation in the principal plane of the fissure ellipsoid at least comprises:
using the greatest fissure vector of the fissure ellipsoid as the first principal direction of the fissure ellipsoid to determine the principal plane of the fissure ellipsoid; making points in a predetermined angular range in each of the first principal direction and the direction reverse to the first principal direction; randomly making points in the second principal direction; based on the included angle between the fissure vector and the principal plane, determining the point-making direction and making points in a mirroring manner for the fissure vectors not belonging to the principal plane; and fitting and calculating the average coverage ratio of the fissure vectors.

8. The method of claim 7, wherein the spatial size of the fault/fissure is described based on the area of the principal plane of the fissure ellipsoid, and
the spatial orientation of the fault/fissure is described based on the normal direction of the principal plane of the fissure ellipsoid,
the size of the fissure is described based on the size of the main plane.

9. A system for quantitative detection of a fault/fissure, the system at least comprising coordinate collecting components and at least one processor, wherein
the coordinate collecting components are for at least collecting spatial coordinate data of the fault/fissure and sending the data to the processor; and
the processor is for:
according to the spatial coordinate data, constructing a fundamental elliptic equation that covers a spatial distribution scope of the fault/fissure; and
according to spatial geometric parameters of a three-dimensional fissure ellipsoid constructed from the fundamental elliptic equation, characterizing the fault/fissure.

10. The system of claim 9, wherein the processor is further for:
based on a third axis parameter of the fissure ellipsoid, describing geometric characteristics of a solid structural defect related to a width; and
based on an area and/or a normal direction of a principal plane of the fissure ellipsoid, describing spatial characteristics of the solid structural defect.

11. The system of claim 10, wherein the processor is further for:
based on an average coverage ratio of the fissure ellipsoid with respect to fissure vectors, assessing ellipsoid fitting quality.

12. The system of claim 11, wherein the processor is further configured for:
according to the spatial coordinate data, constructing a polyhedron that covers the spatial distribution scope of the fault/fissure;
based on a geometric structure of the polyhedron, determining a center of gravity of the polyhedron;
according to the center of gravity and fissure vectors that are each formed by linking the center of gravity and a point of the spatial coordinate data, constructing the fundamental elliptic equation that covers the spatial distribution scope; and
based on the fundamental elliptic equation, forming the three-dimensional fissure ellipsoid.

13. The system of claim 12, wherein the processor is further configured for:
according to quantity of the spatial coordinate data, determining a way by which a coefficient of the fundamental elliptic equation is fit; and
according to the coefficient of the fundamental elliptic equation, determining the spatial geometric parameters of the fissure ellipsoid.

14. The system of claim 13, wherein the processor is further configured for:
where the quantity of the received spatial coordinate data is not smaller than a predetermined data threshold, directly determining the coefficient of the fundamental elliptic equation through fitting; and
where the quantity of the received spatial coordinate data is smaller than the predetermined data threshold, fitting the coefficient of the fundamental elliptic equation by means of performing random interpolation in a principal plane of the fissure ellipsoid.

15. The system of claim 14, wherein the processor is further configured for:
using the greatest fissure vector of the fissure ellipsoid as the first principal direction of the fissure ellipsoid to determine the principal plane of the fissure ellipsoid; making points in a predetermined angular range in each of the first principal direction and the direction reverse to the first principal direction; randomly making points in the second principal direction; based on the included angle between the fissure vector and the principal plane, determining the point-making direction and making points in a mirroring manner for the fissure vectors not belonging to the principal plane; and fitting and calculating the average coverage ratio of the fissure vectors.

16. The system of claim 15, wherein the spatial size of the fault/fissure is described based on the area of the principal plane of the fissure ellipsoid, and
the spatial orientation of the fault/fissure is described based on the normal direction of the principal plane of the fissure ellipsoid.

17. An ellipsoid-based method for quantitative description of a fault/fissure hypocenter, the method at least comprising:
collecting waveform parameters of elastic waves generated during rupture process;
constructing a three-dimensional fundamental elliptic equation that covers spatial radiation of the hypocenter;
according to the fundamental elliptic equation, constructing a three-dimensional hypocenter ellipsoid; and
according to spatial geometric parameters of the ellipsoid, determining a hypocenter location, its energy level, and/or orientation of the fissure.

18. The method of claim 17, further comprising:
representing stress triaxiality, stress status and/or stress orientation based on parameters of three axes of the ellipsoid; and
based on fitting relation between the energy level and the stress, establishing relation between the parameters of the three axes of the hypocenter ellipsoid and the stress, thereby determining a stress tensor and variation thereof.

19. The method of claim 18, wherein the step of constructing a three-dimensional fundamental elliptic equation that covers spatial radiation of the hypocenter at least comprises:
according to quantity of the waveform parameters of the elastic waves, determining a way by which a coefficient of the fundamental elliptic equation is fit; and
according to the coefficient of the fundamental elliptic equation, determining the spatial geometric parameters of the hypocenter ellipsoid.

20. The method of claim 19, further comprising:
connecting the location of the hypocenter and data points of the waveform parameters of the elastic waves to form hypocenter-detecting vectors that represent spatial propagation directions from the hypocenter; and
based on an average coverage ratio of the fissure ellipsoid with respect to the hypocenter-detecting vectors, assessing ellipsoid fitting quality.
